(19) United States
(12) Patent Application Publication
(10) Pub. No.: US 2024/0411624 A1
(43) Pub. Date: Dec. 12, 2024

(54) ENABLING AWARENESS AND COORDINATION AMONG APPLICATIONS

(71) Applicant: CONVIDA WIRELESS, LLC, Wilmington, DE (US)

(72) Inventors: Lu LIU, Conshohocken, PA (US); Dale SEED, Allentown, PA (US); Xu LI, Plainsboro, NJ (US)

(21) Appl. No.: 18/703,832

(22) PCT Filed: Nov. 1, 2022
(86) PCT No.: PCT/US2022/079049

§ 371 Date: Apr. 23, 2024

Related U.S. Application Data
(60) Provisional application No. 63/274,205, filed on Nov. 1, 2021.

(51) Int. Cl. G06F 9/54

(52) U.S. Cl. CPC G06F 9/542; G06F 2209/544

(57) ABSTRACT

An application coordination service (ACS) enables awareness among applications and perform coordination actions regarding these applications. For example, application client may request application coordination service from an ACS client. The ACS client may identify the influencer applications that are of interest, monitor the activities and status of the influencer applications, generate notifications, or determine and perform actions regarding the service request.

### CROSS-REFERENCE TO RELATED APPLICATIONS

This application claims the benefit of U.S. Provisional Patent Application No. 63/274,205, filed on Nov. 1, 2021, entitled “Enabling Awareness and Coordination Among Applications,” the contents of which are hereby incorporated by reference herein.

### BACKGROUND

3GPP defines several functionalities for application enablement, such as the service enabler architecture layer (SEAL), edge enabler layer functions, and application layer support for different types of vertical applications (e.g., vehicle-to-everything, factory, or unmanned aerial system).

This background information is provided to reveal information believed by the applicant to be of possible relevance. No admission is necessarily intended, nor should be construed, that any of the preceding information constitutes prior art.

### SUMMARY

An application coordination service (ACS) enables awareness among applications and perform coordination actions regarding these applications. For example, application client may request application coordination service from an ACS client. The ACS client may identify the influencer applications that are of interest, monitor the activities and status of the influencer applications, generate notifications, or determine and perform actions regarding the service request.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 illustrates an exemplary service enabler architecture layer (3GPP SA6);

FIG. 2 illustrates an exemplary V2X application layer functional model (3GPP SA6);

FIG. 3 illustrates an exemplary architecture for enabling edge applications (3GPP SA6);

FIG. 4 illustrates an exemplary application coordination service framework;

FIG. 5 illustrates an exemplary application coordination procedure;

FIG. 6 illustrates an exemplary coordination service request initiated by influenced application client (AC);

FIG. 7 illustrates an exemplary coordination service request initiated by influenced application server (AS);

FIG. 8 illustrates an exemplary coordination service offer;

FIG. 9 illustrates an exemplary coordination permission request;

FIG. 10 illustrates an exemplary coordination action triggered by activity of influencer AC;

FIG. 11 illustrates an exemplary coordination action triggered by activity of influencer AS;

FIG. 12 illustrates an exemplary edge enabling architecture;

FIG. 13 illustrates an exemplary on top of service enabler architecture layer (SEAL);

FIG. 14 illustrates an exemplary GUI-influenced app view;

FIG. 15 illustrates an exemplary GUI-influencer app view;

FIG. 16 illustrates an illustrates an exemplary method for enabling an approach in which the coordinator may be fully or partially implemented on the UE;

FIG. 17A illustrates an example communications system;

FIG. 17B illustrates an exemplary system that includes RANs and core networks;

FIG. 17C illustrates an exemplary system that includes RANs and core networks;

FIG. 17D illustrates an exemplary system that includes RANs and core networks;

FIG. 17E illustrates another example communications system;

FIG. 17F is a block diagram of an example apparatus or device, such as a WTRU; and

FIG. 17G is a block diagram of an exemplary computing system.

### DETAILED DESCRIPTION

This disclosed subject matter provides for an application coordination service (ACS) functionality to enable awareness among applications and services resident on the same UE and coordinate applications or services that may affect each other. Methods, apparatuses, and systems are disclosed that may be associated with 1) coordination service request and configuration; 2) identifying influencer applications and determining coordination actions; or 3) application monitoring and coordination execution.

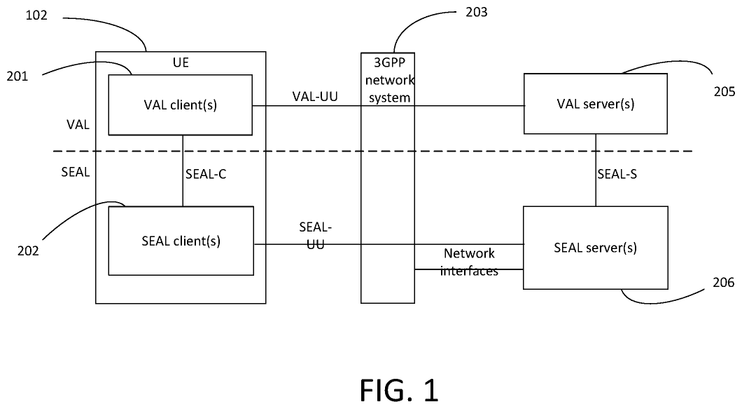

FIG. 1 illustrates an exemplary service enabler architecture layer (3GPP TS 23.434). 3GPP SA6 defines a service enabler architecture layer (SEAL) to support vertical applications over the 3GPP system, including group management, configuration management, location management, identity management, key management, or network resource management. UE 102 may include vertical application layer (VAL) client 201 and SEAL client 202. UE 102 may be communicatively connected via 3GPP system 203 to VAL server 205 or SEAL server 206. Particularly, the SEAL client 202 provides the client-side functionalities corresponding to the specific SEAL service. The SEAL client(s) 202 supports interactions with the vertical application layer (VAL) client(s) 201. The SEAL server 206 provides the server-side functionalities corresponding to the specific SEAL service, and supports interactions with the VAL server(s) 205.

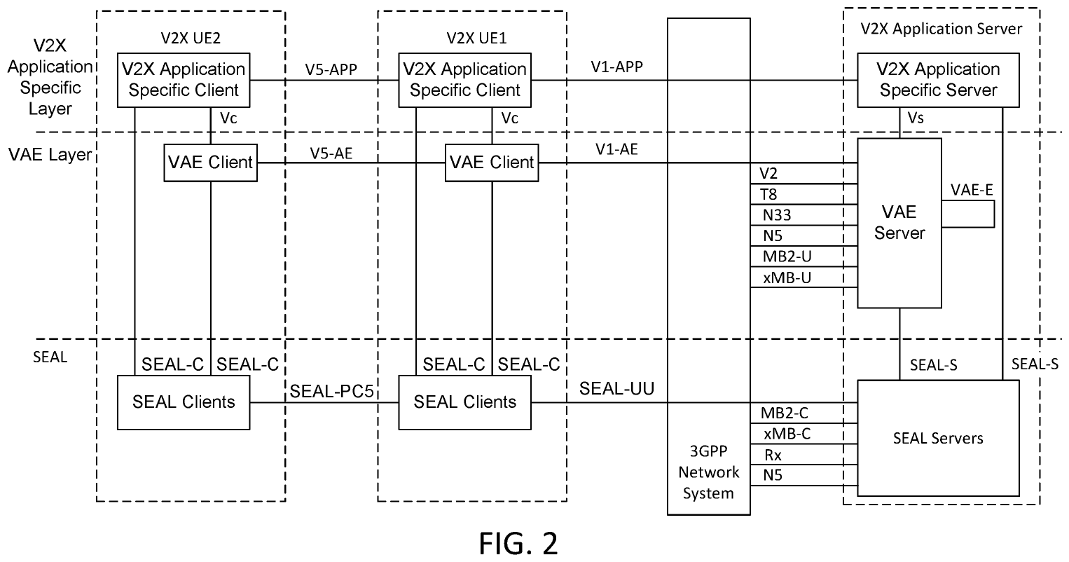

FIG. 2 illustrates an exemplary V2X application layer functional model (3GPP TS 23.286). 3GPP SA6 defines application layer support for vehicle-to-everything (V2X) services. The V2X application enabler (VAE) layer offers the VAE capabilities to the V2X application specific layer.

The VAE client supports interactions with the V2X application specific client(s), and provides the client side V2X application layer support functions such as registration of VAE clients for receiving V2X messages; receiving V2X messages from the VAE server and the delivery to V2X application specific client(s) according to the V2X service ID; receiving network monitoring reports from the VAE server; providing application-level locations to the VAE server; receiving 3GPP system configuration information from the VAE server; or supporting dynamic group management.

The VAE server provides the server side V2X application layer support functions such as: receiving monitoring reports (or events) from the underlying 3GPP network systems regarding network situation corresponding to RAN and core network; supporting registration of V2X UEs; tracking the application level geographic location of the V2X UEs; supporting V2X message distribution for the V2X applications; supporting provisioning of 3GPP system configuration information; providing network monitoring reports to the V2X UEs; communicating V2X service requirements to the underlying 3GPP network systems; maintaining the mapping between the V2X user ID and the V2X UE ID; providing V2X service discovery; supporting V2X service continuity; or supporting V2X application resource adaptation.

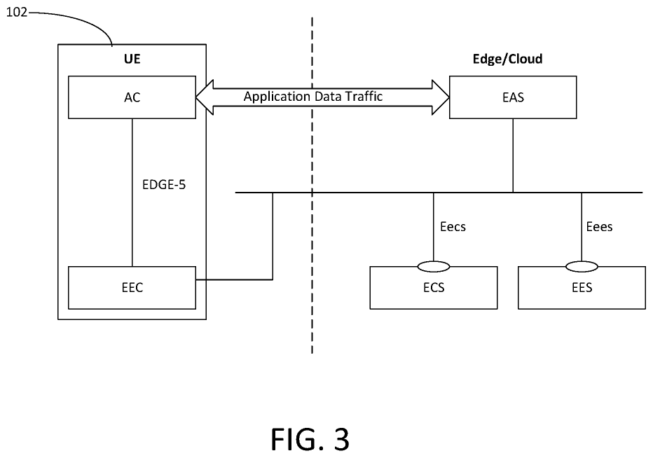

FIG. 3 illustrates an exemplary architecture for enabling edge applications (3GPP TS 23.558). 3GPP SA6 defines an edge enabler client (EEC) and edge enabler servers (EES) to provide edge application enabling functionalities to the application client (AC) in the UE 102 and the edge application server (EAS) in the edge network.

An EEC provides supporting functions needed for AC(s), including retrieval and provisioning of configuration information to enable the exchange of application data traffic with the EAS, and discovery of EASs available in the edge data network (EDN).

An EES provides supporting functions needed for EASs and EECs, including: provisioning of configuration information to EECs, enabling exchange of application data traffic with EASs; supporting the functionalities of API invoker and API exposing function; interacting with 3GPP Core Network for accessing the capabilities of network functions directly or indirectly; supporting the functionalities of application context transfer; supporting external exposure of 3GPP network and service capabilities to the EAS(s); supporting the functionalities of registration (i.e., registration, update, and de-registration) for the EEC(s) and the EAS(s); or supporting the functionalities of triggering EAS instantiation on demand.

Capabilities of UEs have been increasing over time. Nowadays, UE 102 may support running multiple applications at the same time. Applications running on UE 102 may require various resources on UE 102, as well as network bandwidth resources if the applications need to communicate with a server instantiated in the cloud or on an edge node in the network. The status of an application resident on a UE 102 may change dynamically according to its policy, schedule, load, or other conditions. Applications may also be dynamically activated or deactivated on UE 102, while an application server may be dynamically instantiated or relocated as needed.

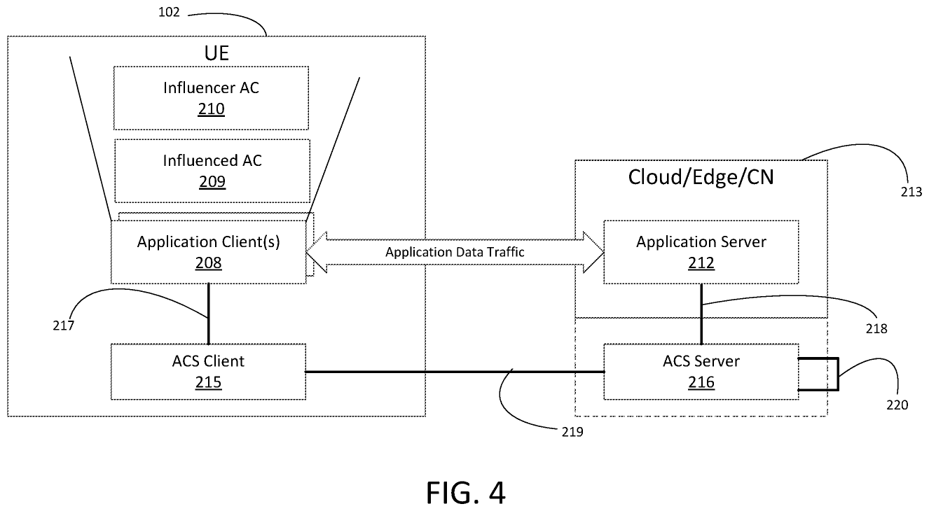

With reference to FIG. 4, for the application clients 208 (e.g., application client 209 or application client 210) running on the same UE 102, the status or activity of one application may have an effect on another. For example, application client 209 of FIG. 4 may consume computation resources on UE 102. If application client 210 requiring the resource is also activated on UE 102, the performance of application client 209 might be affected as less resources will be allocated to it. In this case, application client 209 may need to adjust its behavior accordingly. However, application client 209 may not be aware of the cause of the change, thus it may not be able to react efficiently.

There could also be certain dependency relationships among applications whose clients reside on the same UE 102. For example, an analytics application may rely on the data collected by another application 208. With the deployment of edge computing services, application clients 208 may have the flexibility of using services provided by different instances of application servers 212 hosted in the cloud or on different edge nodes in the network. Use of these different instances can be based on changing location of UE 102, or performance requirements of the application clients 208, among other things. For example, if application client 209 uses services of an application server 212 resident in the cloud or on a specific edge node 213, in some use cases it is preferred that other application clients 210 resident on the same UE 102 and having a relationship with this application client 209 also use services from the same application server 212. This can help minimize the number of different network connections and messages flowing between UE 102 and application servers 212 in the network. However, if one application client 209 is not aware of the decision of another application client 210 to use services of a different application server 212, then this application client 209 may not be able to make timely adjustment to use the same application server 212. Furthermore, when selecting the application server 212, if application client 209 does not know the preference of the other application clients 210 resident on the same UE 102 and having a relationship with this application client 209, the application client 209 may not select the application server 212 that has the preferred or optimally affect processing, memory, bandwidth, or other issues.

In another example, application client 209 is temporarily deactivated, freeing up available resources on UE 102 (e.g., processor, memory, etc.) or in the network (e.g., available bandwidth, load on a particular instance of an application server, etc.) that other application clients 210 may make use of Other application clients 210 may get a notification of this event and one or more of them may try to adjust their behavior to make use of the available resources, such as change their frequency (e.g., schedule) of requests that they issue to a particular application server 212, switch over to a different application server instance, etc.). Without a wholistic view on the behaviors of the applications of UE 102 and coordination, there may be a significant non-optimal use of local resources on UE 102 as well as resources in the network (e.g., application clients 208 attempting to use services from the same application server 212 at the same time, or application client 208 using different application servers 212 when they could more optimally use the same application server 212, etc.).

Furthermore, existing coordination functionalities on UE 102 (e.g., resource allocation functions, CPU scheduler) may only perform coordination actions regarding a certain module, which may not be able to capture the application effect that is generated across multiple modules. For example, for application clients 208 that are sharing or competing for CPU resources, a CPU scheduler might be able to perform actions regarding allocating CPU resources for application clients 208. In the meanwhile, application clients 208 may also be sharing or competing for bandwidth resources, which may affect the achievable CPU usage (e.g., efficiency). In this case, the CPU scheduler by itself may not be able to jointly consider various types of effects between application clients 208 when making the CPU allocation decisions, while a higher-layer or over-the-top coordination mechanism is preferred.

The aforementioned scenarios are examples that indicate that application clients 209 may face a lack of awareness of the other applications 210 that may potentially have an effect on them. Also, there is a lack of coordination among such applications. Without the support of application awareness and coordination, applications may not properly or proactively adapt their behavior accordingly, which may potentially impact the performance of applications and the efficiency of resource usage (e.g., local resource on UE 102 and resources in the network).

As disclosed in more detail herein, one application 209 may be potentially affected by another application 210 in the sense that the former may need to adjust its policy or activities when the latter performs a certain action, or the status of the latter has changed. In this case, application client 209 may be interested in the status and activity of application client 210. In order for an application to be aware of other applications that are of interest and have their activities coordinated, the application may require awareness and coordination service from an application coordinator. The application coordinator may be implemented at the client side (the UE 102), or at the server side (e.g., in the core network, on the edge nodes 213), or both. The application coordinator may provide awareness and coordination services to applications by helping application client 209, which is influenced, identify application clients 210 (e.g., influencer applications) that are of interest, monitoring activities of the influencer applications, generating notifications, or performing actions regarding the influenced application when applicable.

Note, although the examples disclosed herein show coordination of applications resident on UEs 102 and in the network, it is contemplated that the disclosed approaches may also be applied to coordination of services resident on UEs 102 and in the network as well.

FIG. 4 illustrates an exemplary application coordination service (ACS) framework. Application clients (AC) 208 may be the application or service resident in UE 102 performing the client function, such as a 3GPP SA6 defined application client, VAL client, or application specific client.

Influenced AC may be the client of an application that may potentially be affected by another application, such as an application client resident on the same UE 102 or an application server 212 serving the same UE 102, e.g., influencer application. An influenced AC may initiate a coordination service request to ACS client 215 or receive a coordination service offer from ACS client 215.

Application server 212 may perform the server functions of an application or service, which may be resident in the cloud, at the edge, or in the core network (CN), such as a 3GPP SA6 defined application server, edge application server (EAS), VAL server, or application specific server.

Influenced AS is the server of application client 209 that may be potentially affected by another application 210, such as an application server 212 serving the same UE 102 as the influenced AS 212 or an application client 208 resident on the UE that the influenced AS 212 is serving, e.g., influencer application 210. An influenced AS 212 may initiate a coordination service request to ACS server 216 or receive a coordination service offer from ACS server 216.

ACS client 215 is the ACS functional entity resident on UE 102 that may provide supporting functions needed for the influenced ACs 212 and the ACS server 216. ACS client 215 may be a 3GPP SA6 defined client-side entity, such as edge enabler client (EEC), vertical application enablement client, etc.

ACS server 216 may be the ACS functional entity resident in the core network or in an edge (or cloud) node 213 that may provide supporting functions needed for the influenced ASs 209 and ACS client 215. ACS server 216 may be a 3GPP SA6 defined server-side entity, such as edge enabler server (EES), vertical application enablement server, etc. ACS server 216 may be co-located with the application servers being served (e.g., ACS server is an EES and co-located with EASs), or it may be located in the core network and serving application servers 212 that are hosted at different locations.

Application client 208 to ACS client 215 reference point (e.g., reference point 217) enables interactions between the application client (of the influenced application or influencer application) and ACS client 215. It supports the client-side coordination service influenced procedure, status monitoring and information collection from the application client 208 by ACS client 215, notification procedure from ACS client 215 to application client 208, and other coordination procedures between ACS client 215 and application client 208.

Application server 212 to ACS server 216 reference point (e.g., reference point 218) enables interactions between application server 212 (of the influenced application or influencer application) and ACS server 216. It supports the server-side coordination service influenced procedure, status monitoring and information collection from application server 212 by ACS server 216, notification procedure from ACS server 216 to application server 212, and other coordination procedures between ACS server 216 and application server 212.

ACS client 215 to ACS server 216 reference point (e.g., reference point 219) enables interactions between ACS server 216 and ACS client 215. It supports the information sharing and notifications between ACS server 216 and ACS client 215. For example, it may be used by ACS client 215 to provide influenced or influencer application client information to ACS server 216, or used by ACS server 216 to provide influenced or influencer application server information to ACS client 215. It may also be utilized to exchange notifications and other messages between ACS client 215 and ACS server 216 when coordination actions are triggered.

ACS server 216 to ACS server 216 reference point (e.g., reference point 220) enables interactions between different ACS servers 216. If the application servers 216 associated with the same UE 102 are receiving coordination services from different ACS servers 216 (e.g., a UE 102 may receive services from EASs hosted at different edge nodes which are associated with different EESs and ACS servers 216), these ACS servers 216 may share information via this reference point 220.

An application coordination service (ACS) is disclosed to enable awareness among applications and perform coordination actions regarding these applications. For example, application client 209 or application server 212 may request or be offered application coordination service from ACS client 215 or ACS server 216. ACS client 215 (or server) may identify the influencer applications 210 that are of interest, monitor the activities and status of the influencer applications 210, generate notifications, or determine and perform actions regarding the service request when applicable.

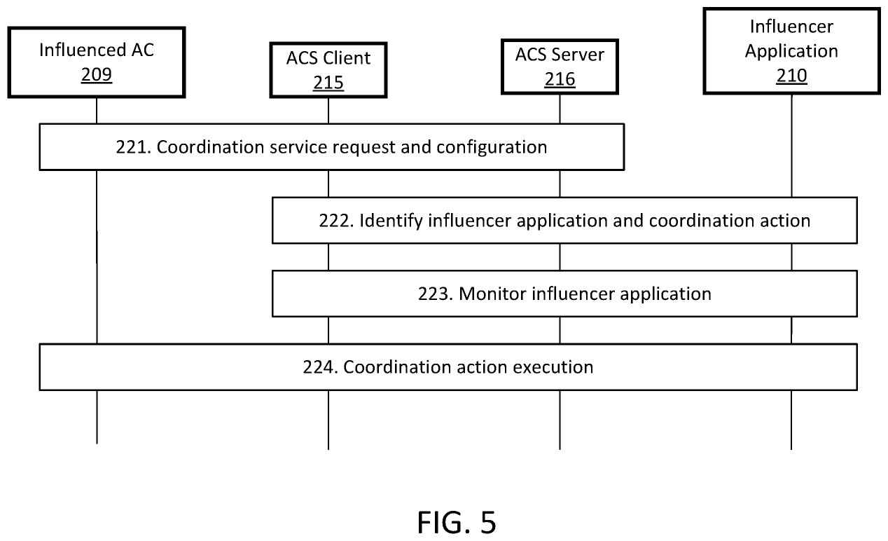

The overall procedure of the application coordination service is illustrated in FIG. 5. At step 221 of FIG. 5, influenced AC 209 (or AS 212) may send a coordination service request to ACS client 215 (or server which is contemplated herein throughout as an option) providing information of itself and influencer application 210. Alternatively, the ACS may offer the coordination service to an application that may be affected by others. Detailed procedures are described herein regarding coordination of service requests.

At step 222 of FIG. 5, based on information obtained from step 221 of FIG. 5 and gathered by the ACS, ACS client 215 (or server) may identify the influencer application client 210 (or server) and determine the coordination action corresponding to different activities (e.g., actions or behaviors of an application) or events (e.g., status of the application) of influencer application 210. The information will be recorded in the coordination action table. ACS client 215 (or server) may further send a coordination permission request to the identified influencer application client 210. Detailed procedures are described herein regarding identifying influencer application client 210 and determining coordination action.

At step 223 of FIG. 5, ACS may monitor activity or status of influencer application(s) 210 to detect activities and events that may affect influenced AC 209 (or AS).

Step 224 of FIG. 5, according to the coordination action table, ACS client 215 (or server) may take the corresponding actions when an activity (or event) of the influencer application 210 is detected. Detailed procedures of step 223 of FIG. 5 and step 224 of FIG. 5 are described with reference to application monitoring and coordination action.

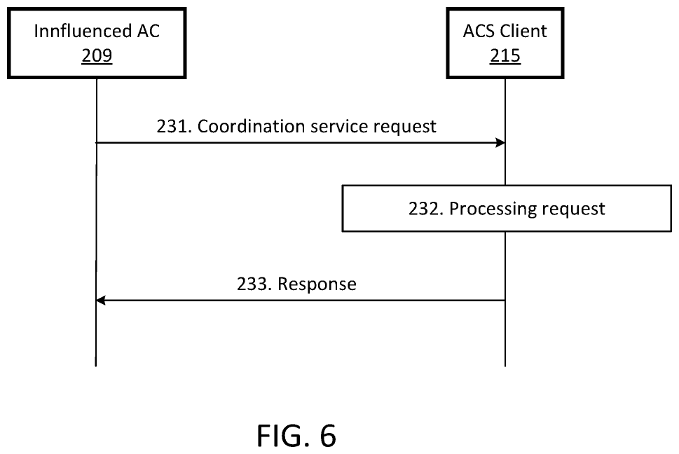

FIG. 6 illustrates an exemplary coordination service request procedure initiated by influenced AC 209. An application may request coordination service from ACS client 215 (or server). The request may be initiated by influenced AC 209 (or influenced AS 212 is contemplated herein).

At step 231 of FIG. 6, influenced AC 209 may request for the coordination service by sending an explicit request to ACS client 215 or including an indication for the request in a message sent to ACS client 215, such as a registration request, a service provisioning request, or a configuration request, among other things. Table 1 describes information elements that may be included in the service coordination request from the influenced AC 209 to ACS client 215.

TABLE 1

| Information element | Description |
|---|---|
| Coordination service | This information element is used when the coordination service |
| indicator | request is embedded in another message sent from the AC to ACS |
| | client 215 (rather than an explicit request message), which indicates |
| | that the AC is influenced application coordination service. |
| Influenced AC | The description of the influenced AC may include on or more of the |
| description | following information: |
| | Category or type of the AC, schedule of the AC, required resources, |
| | service requirement and preference, supported services (e.g., dynamic |
| | instantiation, flexible schedule or requirements). |
| | This information element does not necessarily provide a |
| | comprehensive description of the influenced AC. However, the |
| | descriptions included in this information element may imply how the |
| | influenced AC may be affected by the influencer application(s). For |
| | example, the required resource types and schedule information of the |
| | influenced AC may indicate that it may be potentially affected by |
| | applications that are using the same types of resources in the same |
| | schedule. |
| | This description can also be used by ACS client 215 to determine the |
| | influencer application(s) and coordination action if they are not |
| | specified by the influenced AC. |
| Callback address | Name or address of a callback function or resource which may be |
| | used by ACS client 215 to issue a callback or send a notification to the |
| | influenced AC. |
| Influencer application | Describes which influencer applications are of interest to the |
| description | influenced AC. |
| | The description may include identifier of the corresponding |
| | application client (or server), category or type of the application, |
| | schedule of the application, required resources, service requirement |
| | and preference, priority, location of the application server instance |
| | (e.g., cloud, edge, local), etc. |
| Influencer application | Describes the criteria that further qualify specific modules of the |
| criteria | influencer applications that are of interest to the influenced AC. |
| | The criteria may include: overlapped schedule between the influencer |
| | applications and the influenced AC, resource competition between the |
| | influencer applications and the influenced AC (they have the same |
| | resource usage requirements), influencer applications are of higher |
| | priority than the influenced AC, the corresponding EASs are hosted |
| | on the same edge node, influencer application state transitions of |
| | interest (e.g., active, inactive), actions of interest that are performed |
| | by the influencer applications (e.g., EEC associated with the |
| | influencer application has registered/deregistered to specified EES, or |
| | the AC has connected to specified EAS, etc.). |
| Coordination action | Describes the expected action(s) to be taken by ACS client 215 for |
| | service coordination, which may be allowed/supported by the |
| | influenced AC. |
| | The coordination action may include: issuing a notification or callback |
| | to the influenced AC (to have it perform an AC specific action) |
| | regarding the influencer application event of interest that has |
| | occurred, notifying the influenced AC of when, how, and how long it |
| | would be affected (and by which application), sending a request to the |
| | influenced AC for a service requirement/schedule adjustment (e.g., |
| | changing/throttling the rate of requests issued by the influenced AC), |
| | triggering a request to activate/deactivate/instantiate/suspend the |
| | influenced AC or the AS that is serving the influenced AC, triggering |
| | a relocation of the AS associated with the influenced AC, triggering a |
| | grouping operation that includes the influenced AC. |
| | The coordination action may further include: sending a notification to |
| | the influencer application (e.g., notifying the corresponding AC (or |
| | AS) that the influenced AC has been affected by the action/activity of |
| | the influencer application), sending a (negotiation) request to the |
| | influencer application (e.g., a request to delay/reschedule/reverse the |
| | activity of the influencer application). |
| Coordination | This information element indicates if the influenced AC allows ACS |
| permission | client 215 to collect information and monitor its status in case the |
| | influenced AC becomes an influencer application for another |
| | application. |

At step 232 of FIG. 6, ACS client 215 processes the request which may include checking if any additional information (e.g., information in Table 1) is needed from influenced AC 209. ACS client 215 may require additional information if it has not been provided by the influenced AC 209 in step 231.

At step 233 of FIG. 6, ACS client 215 may send a response to influenced AC 209 acknowledging that the request has been accepted. If ACS client 215 has identified that additional information is required from influenced AC 209 (in step 233 of FIG. 6), ACS client 215 may include a request for such information embedded in the response message.

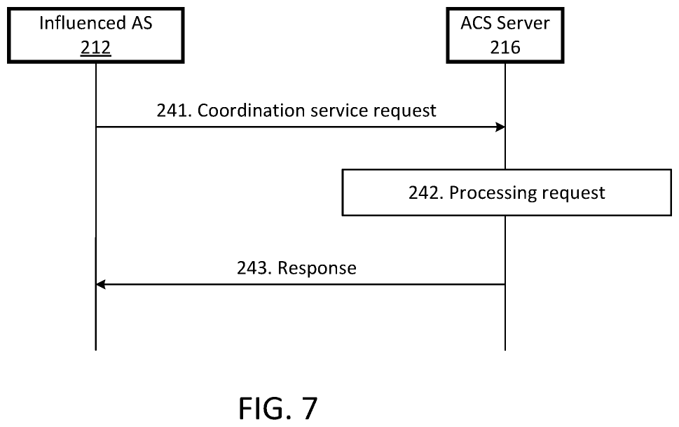

FIG. 7 illustrates the coordination service request procedure initiated by influenced AS 212. At step 241 of FIG. 7, influenced AS 212 may request for the coordination service by sending an explicit request to ACS server 216 or including an indication for the request in a message sent to ACS server 216, such as a registration request, a service provisioning request, a configuration request, etc. Table 2 describes information elements that may be included in the service coordination request from influenced AS to ACS server 216.

TABLE 2

| Information element | Description |
|---|---|
| Coordination service | This information element is used when the coordination service |
| indicator | request is embedded in another message sent from the AS to ACS |
| | server 216 (rather than an explicit request message), which indicates |
| | that the AS is influenced application coordination service. |
| Influenced AS | The description of the influenced AS may include on or more of the |
| description | following information: |
| | Category or type of the AS, schedule of the AS, required resources, |
| | service requirement and preference, supported services (e.g., dynamic |
| | instantiation, flexible schedule or requirements). |
| | This information element does not necessarily provide a |
| | comprehensive description of the influenced AS. However, the |
| | descriptions included in this information element may imply how the |
| | influenced AS may be affected by the influencer application. This |
| | description can also be used by ACS server 216 to determine the |
| | influencer application and coordination action if they are not specified |
| | by the influenced AS. |
| | This description can also be used by ACS server 216 to determine the |
| | influencer application(s) and coordination action if they are not |
| | specified by the influenced AS. |
| Callback address | Name or address of a callback function or resource which may be |
| | used by ACS server 216 to issue a callback or send a notification to |
| | the influenced AS. |
| Influencer application | Describes which influencer applications are of interest to the |
| description | influenced AS. |
| | The description may include identifier of the corresponding |
| | application client (or server), category or type of the application, |
| | schedule of the application, required resources, service requirement |
| | and preference, priority, location of the application server instance |
| | (e.g., cloud, edge, local), etc. |
| Influencer application | Describes the criteria that further qualify specific modules of the |
| criteria | influencer applications that are of interest to the influenced AS. |
| | The criteria may include: overlapped schedule between the AS of an |
| | influencer application and the influenced AS, resource competition |
| | between the influencer application and the influenced AS (they have |
| | the same resource usage requirements), influencer applications are of |
| | higher priority than the influenced AS, the corresponding EASs are |
| | hosted on the same edge node, influencer application state transitions |
| | of interest (e.g., active, inactive), actions of interest that are performed |
| | by the influencer application (e.g., EEC associated with the influencer |
| | application has registered/deregistered to specified EES, or the AC |
| | has connected to specified EAS, etc.). |
| Coordination action | Describes the expected action(s) to be taken by ACS server 216 for |
| | service coordination, which may be allowed/supported by the |
| | influenced AS. |
| | The coordination action may include: issuing a notification or callback |
| | to the influenced AS (to have it perform an AS specific action) |
| | regarding the influencer application event of interest that has |
| | occurred, notifying the influenced AS of when, how and how long it |
| | would be affected (and by which application), sending a request to the |
| | influenced AS for a service requirement/schedule adjustment, |
| | triggering a request to activate/deactivate/instantiate/suspend the |
| | influenced AS or the AC that is receiving service from the influenced |
| | AS, triggering an AS relocation, triggering a grouping operation that |
| | includes the influenced AS. |
| | The coordination action may further include: sending a notification to |
| | the influencer application (e.g., notifying the corresponding AC (or |
| | AS) that the influenced AS has been affected by the action/activity of |
| | the influencer application), sending a (negotiation) request to the |
| | influencer application (e.g., a request to delay/reschedule/reverse the |
| | activity of the influencer application). |
| Coordination | This information element indicates if the influenced AS allows ACS |
| permission | server 216 to collect information and monitor its status in case the |
| | influenced AS becomes an influencer application for another |
| | application. |

At step 242 of FIG. 7, ACS server 216 processes the request and checks if any additional information is needed from influenced AS 212.

At step 243 of FIG. 7, ACS server 216 sends a response to the influenced AS 212 acknowledging that the request has been accepted. If ACS server 216 has identified that additional information is required from the influenced AS 212 (in step 242 of FIG. 7), ACS server 216 may include a request for such information embedded in the response message.

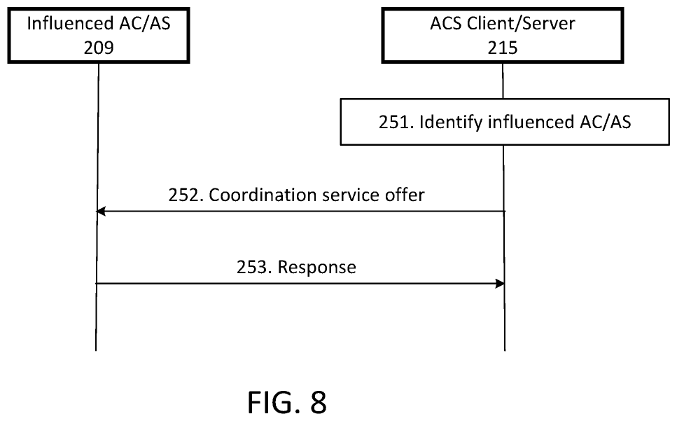

Alternatively, ACS client 215 (or server) may initiate an offer of the coordination service to an influenced application client 209 (or server), as illustrated in FIG. 8.

At step 251 of FIG. 8, ACS client 215 (or ACS server 216 may be applicable) may identify that influenced application client 209 may be potentially affected by another application (e.g., influencer application client 210). For example, ACS client 215 (or server) may obtain information of influencer application client 210 (or server) after receiving a registration request from influencer application client 210 (or server). Based on the information, ACS client 215 may identify that the registering AC 209 (or AS 212) may be potentially affected by another AC 209 (or AS 212) that has previously registered. In this case, ACS client 215 proactively offer the coordination service to the registering AC 209 (or AS 212), which is identified as an influenced AC 209 (or AS 212).

At step 252 of FIG. 8, ACS client 215 (or server) may send a coordination service offer to the identified influenced AC 209 (or AS). In this message, ACS client 215 (or server) may indicate what information is required from the influenced AC 209 (or AS 212) in order to provide the coordination service, such as the information described in Table 1 and Table 2. This offer may be sent as a dedicated request or embedded within another message (e.g., the response to a registration request from the influenced application client 209 (or server))

At step 253 of FIG. 8, if influenced AC 209 (or AS) accepts the coordination service offer, it may send a response to ACS client 215 (or server), providing the information required by ACS client 215 (including the information elements as described in Table 1 and Table 2).

Influenced AC 209 (or AS) may not be able to specify which application client 208 will be the influencer application client 210 as it may not be aware of the other applications running on or serving the same UE 102. For the same influenced AC 209 (or AS), different influencer application clients 210 or different activities of the influencer application clients 210 may affect the influenced AC 209 (or AS) differently, requiring different coordination actions to be taken by ACS client 215 (or server). In this case, the coordination service may help identify the influencer application clients 210 and the corresponding coordination actions based on the information provided by the influenced AC 209 (or AS) and other information collected by ACS client 215 (or server).

The information collected or requested by ACS client 215 (or server) may include the information below and herein, such as information of other ACs, information of the ASs, or UE context information, among other information. Information of other ACs 210 that are resident on UE 102 (e.g., AC profile, application characteristics (e.g., expected traffic over time)) may be provided by AC 210 to ACS client 215 (and shared with ACS server 216, if applicable). Alternatively, ACS client 215 may send a (subscription) request to the other ACs 210 for such information.

Information of the ASs of other applications that are serving the UE (e.g., AS (or EAS) profile, application characteristics (e.g., expected traffic over time)) may be provided by ASs 212 to ACS server 216 (or shared with ACS client 215, if applicable). Alternatively, ACS server 216 may send a (subscription) request to the other ASs 212 for such information.

UE context information, such as the network conditions (e.g., load or congestion), access information (e.g. 3GPP access, non-3GPP access), cell type (e.g. macro cell, small cell), user experienced data rate, traffic characteristic of UE 102 (e.g. mobility information, no mobility, nomadic, spatially restricted mobility, or full mobility), location, sensor-level information (e.g. direction, speed, power status, display status, or other sensor information installed in UE 102), or application-level information (e.g. foreground applications, running background application, or user settings).

Based on the information, ACS client 215 (or server) may identify the influencer AC 210. The influencer application clients 210 may be applications that are already running on or serving UE 102, or they may be applications that are currently not running on or serving UE 102. The following approaches may be taken in order to identify influencer application clients 210.

An approach may be to perform an AC (or AS) discovery of the influencer application clients 210 where the discovery filter is set according to the information specified in the influencer application client description in the coordination service request, such as the identifier of the influencer AC 210 (or AS), category or type of the application, schedule of the application, required resources, or priority, among other things.

An approach may be to find applications that match the conditions defined in the influencer application criteria in the coordination service request, such as applications that are sharing the same resources as the influenced application, applications that have similar schedules as the influenced AC 209 (or AS), or applications using EASs instantiated at the same edge node, among other things.

An approach may be if influencer application description or influencer application criteria is not specified, ACS client 215 (or server) may look for all applications that may potentially have an effect on the influenced AC 209 (or AS) based on the influenced AC (or AS) description. For example, if an influenced AC 209 specifies its resource requirement in the description, then applications that are competing for resources with the influenced AC 209 may be identified as influencer applications. If influenced AS 212 specifies its server instance location in the description, then applications with server instances located at the same node may be identified as influencer ACs 210.

After the influencer application(s) 210 are identified, ACS client 215 (or server) may further determine which activities of the identified influencer applications are of interest to the influenced AC 209 (or AS) based on the influencer application description or criteria, such as an adaption of resource usage, changing level of activeness, activation/deactivation of the corresponding AC (or AS), or AS instantiation, among other things.

For the same influenced AC 209 (or AS) and the same influencer AC 210, different activities of the influencer AC 210 may correspond to different coordination actions. According to the identified influencer AC 210 and its possible activities, ACS client 215 (or server) may further identify which action should be taken for each activity based on the coordination action defined in the service request. If no coordination action is specified, a default action may be applied, such as sending a notification to the influenced AC 209 (or AS).

For the identified influencer AC 210, the possible activities and the corresponding coordination actions will be recorded by ACS client 215 (or server) in a coordination action table. The table may be maintained at ACS client 215, ACS server 216, or at both. The example entries in the table may be organized according to the influenced AC 209 (or AS) (Table 3) or the influencer AC 210 (Table 4). Table 3 is an example coordination action table—according to influenced AC 209 (or AS). Table 4 is an example coordination action table—according to influencer application.

TABLE 3

| Requestor | Influencer | | |
|---|---|---|---|
| (Identifier | application | | |
| of the | (Identifier of | Influencer | |
| influenced | the influencer | application | Coordination |
| AC (or AS)) | application) | activity | action |
| AC - 1 | Application 3 | Activity X | Send notification |
| | | Activity Y | Trigger request |
| | Application 4 | Activity X | Send notification |
| AS - 2 | Application 3 | Activity X | Send notification |
| | Application 4 | Activity Y | Trigger request |

TABLE 4

| | | Corresponding | |
|---|---|---|---|
| Influencer | | requestor | |
| application | | (Identifier of | |
| (Identifier of | Influencer | the corresponding | |
| the influencer | application | influenced AC | Coordination |
| application) | activity | (or AS)) | action |
| Application 3 | Activity X | AC - 1 | Send notification |
| | | AS - 2 | Send notification |
| | Activity Y | AC - 1 | Trigger request |
| Application 4 | Activity X | AC - 1 | Send notification |
| | Activity Y | AS - 2 | Trigger request |

ACS client 215 (or server) may further optimize the coordination action table to reduce the storage and communication overhead of the table. For example, similar entries may be merged or combined, applications that have similar behavior or effect may be grouped, etc.

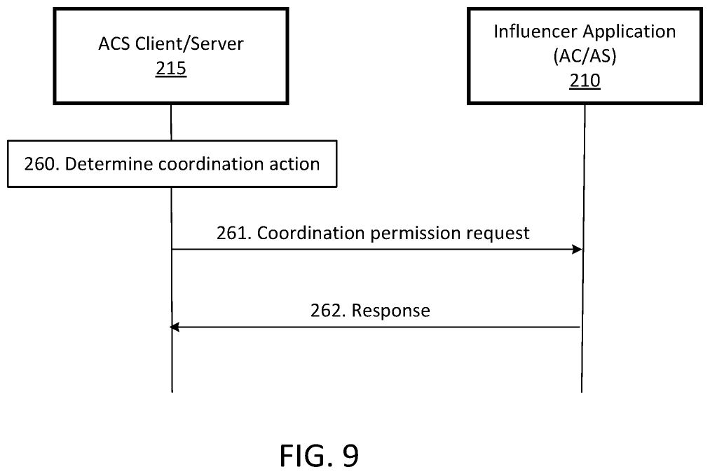

While in general the information of an influencer application and its activities is available to ACS client 215 (or server), ACS client 215 (or server) may not be allowed to share the information with the influenced AC 209 (or AS) or perform certain coordination action unless permitted by the influencer AC 210. In this case, the ACS may send a coordination permission request to the influencer AC 210, as illustrated in FIG. 9. Alternatively, an influencer AC 210 may configure the ACS with coordination permissions.

At step 260 of FIG. 9, after ACS client 215 determines an influencer application and the corresponding coordination actions, ACS client 215 (or server) determines that a permission request is needed to be sent to influencer AC 210 (or AS).

At step 261 of FIG. 9, ACS client 215 (or server) sends a coordination permission request to the influencer AC 210 (or AS). The coordination permission request may be embedded in other messages sent from ACS client 215 (or server) to the influencer application (e.g., a subscription request in order to obtain dynamic information from the influencer application). Table 5 describes information elements that may be included in the coordination permission request from ACS client 215 (or server) to influencer AC 210 (or AS).

TABLE 5

| Information element | Description |
|---|---|
| Coordination information | Describes what information of the |
| | influencer application will be shared |
| | to the influenced application. The |
| | identifier(s) of the corresponding |
| | influenced AC (or AS) may also be |
| | included. |
| Coordination action | Describes coordination actions |
| | related to the influencer application |
| | that will be performed. The |
| | identifier(s) of the corresponding |
| | influenced AC (or AS) may also be |
| | included. |
| Coordination action | If the coordination action table is |
| table | organized according to the influencer |
| | application (as in Table 4), then the |
| | row(s) associated with this influencer |
| | application may be included in the |
| | permission request. |

At step 262 of FIG. 9, influencer AC 210 sends a response to ACS client 215 (or server) indicating if the request is permitted. Influencer AC 210 may further specify which information may be shared or which coordination action is allowed.

Based on the coordination action table, ACS client 215 (or server) will monitor the status and activity of the influencer AC 210 and detect activities that may have an effect on the influenced AC 209 (or AS). The activities of influencer AC 210 may be detected by ACS client 215 (or server) by receiving a notification from the influencer AC 210 indicating their activity or update, monitoring the resource usage or communication rate of the influencer AC 210, receiving a registration or provisioning request initiated by the influencer AC 210, receiving a request to perform a certain action on the influencer AC 210, etc. ACS client 215 and server may notify each other when an activity is detected. Exemplary activities of influencer AC 210 may include resource utilization of the influencer application has exceeded a certain threshold or dropped below a threshold; communication rate or traffic between the AS of the influencer AC 210 and UE 102 has changed or crossed a threshold; AC or AS of the influencer AC 210 has been activated or deactivated; or AS of the influencer application has been relocated.

When a certain activity of the influencer AC 210 has been detected, ACS client 215 (or server) may jointly consider all the influenced AC 209 (or ASs) that will be affected and determine if an action should be taken and coordinate the actions. For example, if the action is to send a notification to the influenced AC 209 (or AS), ACS client 215 (or server) may determine if the notification should be sent based on the notification setting (e.g., frequency limit). After an action is performed by ACS client 215 (or server), it may send a notification of what action has been performed to the ACS server 216 or ACS client 215.

ACS (e.g., ACS server 216 or ACS client 215) may predict if there is a cascaded effect when performing an action and determine the next action proactively. For example, AC 209 may affect AC 210. When a coordination action is triggered (e.g., send a request to AC 210 to adjust its schedule), ACS may determine if performing the action may further affect another application client 208. If so, ACS may determine the next coordination action regarding another application client 208 and perform the action proactively. If another application client 208 may be affected by both AC 209 and AC 210, the ACS may aggregate the coordination actions regarding application client 208.

When there are more than one influenced AC 209 (or AS) that is associated with the influencer AC 210 and the detected activity, ACS client 215 (or server) may further examine the coordination table to determine if performing the expected action on one influenced AC 209 (or AS) will affect another influenced AC 209 (or AS). If not, the expected action may be performed on each influenced AC 209 (or AS). If so, ACS client 215 (or server) may selectively perform the expected actions on one or more of the influenced ACs 209 (or ASs) (e.g., based on priority, or random selection, or alternating among group members), adding the effect of these actions to the effect of the influencer AC 210 (or AS), then determine what action should be taken for the other influenced ACs 209 (or ASs). For example, influencer AC 210 has increased its traffic and resource consumption. Among the influenced ACs 209 (or ASs) that are competing for the same resource with influencer AC 210, ACS client 215 (or server) may send a request to scale back resource usage to some of them while performing no action on the others.

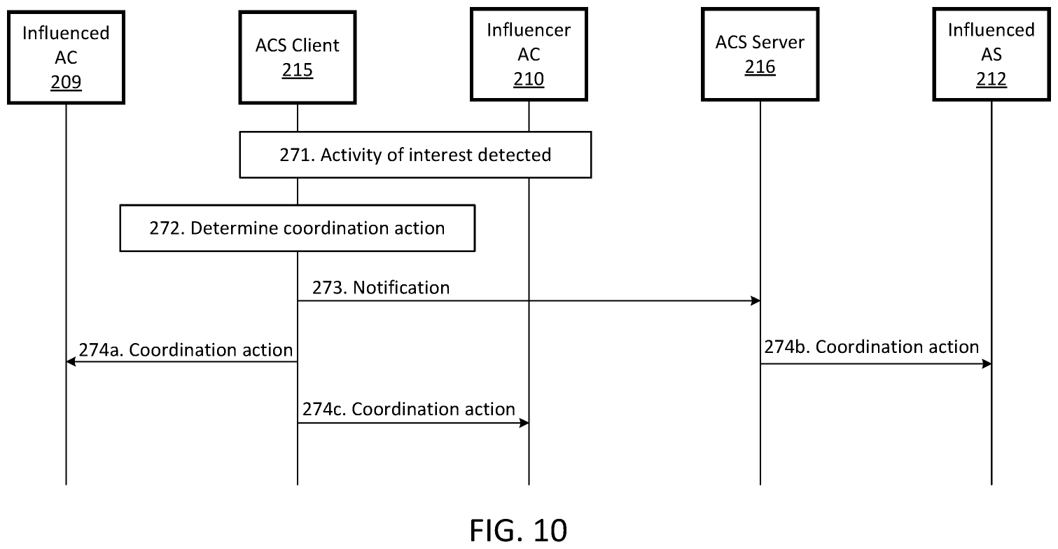

The procedure of performing coordination action that is triggered by an influencer AC 209 is illustrated in FIG. 10. At step 271 of FIG. 10, ACS client 215 may detect an activity of interest from an influencer AC 210.

At step 272 of FIG. 10, ACS client 215 checks the coordination action table to identify the corresponding influenced ACs 209 and ASs 212 that may be affected by the activity and determine the coordination action to take.

At step 273 of FIG. 10, ACS client 215 may send a notification to the ACS server(s) 216 of the detected activity and influencer AC 210. Depending on the coordination action and the influenced AC 209 (or AS) that is involved, one or more of the following steps might be taken.

At step 274a of FIG. 10, if ACS client 215 may determine that a coordination action should be taken regarding one or more influenced ACs 209 (according to the coordination action table), ACS client 215 may perform the action, such as sending a notification or request to influenced AC(s) 209. ACS client 215 may or may not reveal the identity of the influencer AC 210, depending on if it is requested by influenced AC 209 and if it is permitted by influencer AC 210.

At step 274b of FIG. 10, if a coordination action should be taken regarding one or more influenced ASs 212 (according to the coordination action table) and the corresponding ACS server(s) 216 has received the notification from ACS client 215, ACS server(s) 216 may perform the action, such as sending a notification or request to influenced AS(s) 209. ACS server 216 may or may not reveal the identity of influencer AC 210, depending on if it is requested by influenced AS 209 and if it is permitted by influencer AC 210.

At step 274c of FIG. 10, if ACS client 215 may determine that a coordination action should be taken regarding the influencer AC 210, ACS client 215 may perform the action, such as to send a (negotiation) request to influencer AC 210.

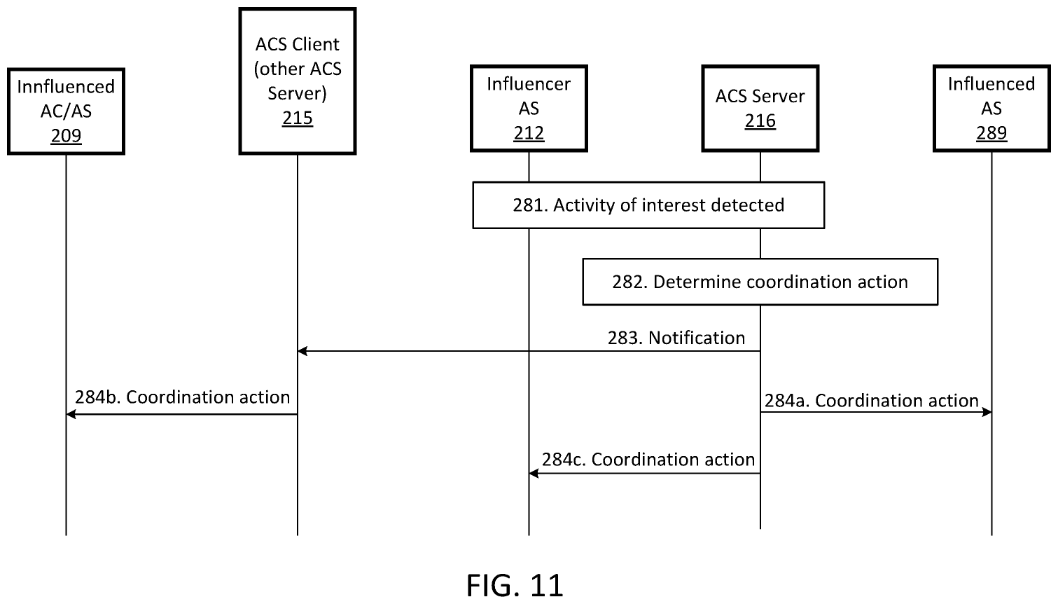

The procedure of performing coordination action that is triggered by influencer AS 210 is illustrated in FIG. 11. At step 281 of FIG. 11, ACS server 216 may detect an activity of interest from influencer AS 212.

At step 282 of FIG. 11, ACS server 216 may check the coordination action table to identify the corresponding influenced ASs 212 and ACs 209 that may be affected by the activity and determine the coordination action to take.

At step 283 of FIG. 11, ACS server 216 may send a notification to ACS client 215 of the detected activity and influencer AC 210. ACS server 216 may also send a notification to the other ACS server(s) 216 if the identified influenced AS 212 is associated with a different ACS server.

Depending on the coordination action and the influenced AC 209 (or AS) that is involved, one or more of the following steps might be taken.

At step 284a of FIG. 11, if ACS server 216 may determine that a coordination action should be taken regarding one or more influenced ASs 289 (e.g., according to the coordination action table), ACS server 216 may perform the action, such as sending a notification or request to influenced AS(s) 289. ACS server 216 may or may not reveal the identity of influencer AS 212, depending on if it is requested by influenced AS 289 and if it is permitted by influencer AS 212.

At step 284b of FIG. 11, if a coordination action should be taken regarding one or more influenced ACs 209 (e.g., according to the coordination action table) or the corresponding ACS client 215 has received the notification from ACS server 216, ACS client 215 may perform the action, such as sending a notification or request to influenced AC(s) 209. If a coordination action should be taken regarding one or more influenced ASs 289 that are associated with other ACS server(s) 215 and the other ACS server(s) 215 has received the notification from the current ACS server 216, the other ACS server(s) 215 may perform the action, such as sending a notification or request to the influenced AS(s) 289. ACS client 215 (or server) may or may not reveal the identity of influencer AS 212, depending on if it is requested by influenced AC (or AS) 209 and if it is permitted by influencer AS 212.

At step 284c of FIG. 11, if ACS server 216 determines that a coordination action should be taken regarding influencer AS 212, ACS server 216 may perform the action, such as to send a (negotiation) request to influencer AS 212.

The disclosed application coordination service and function may be realized as an enhancement to the application enablement functions defined in 3GPP SA6, where ACS server 216 may be co-deployed with the server-side functional entity, and ACS client 215 may be co-deployed with the client-side functional entity. For example, shows an example edge application enabling architecture.

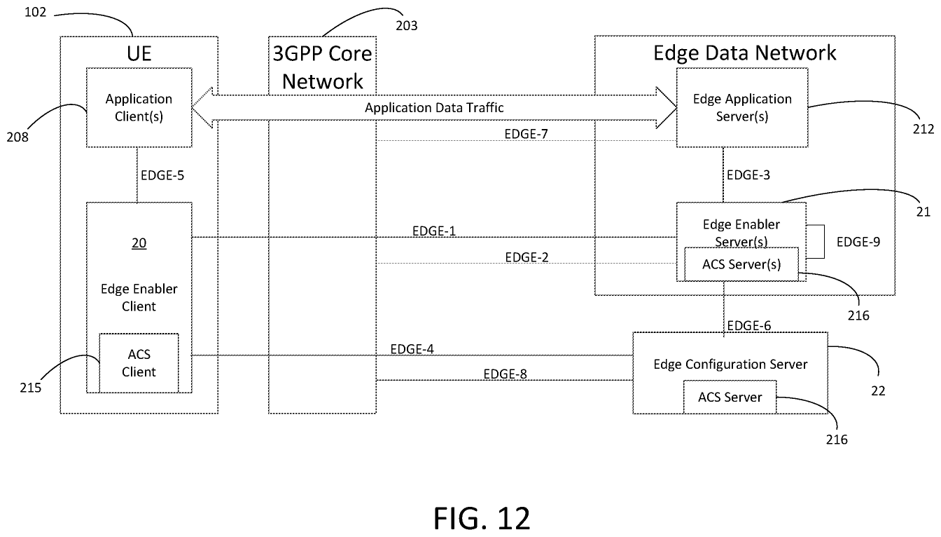

As shown in FIG. 12, the client-side ACS functionalities may be added to the edge enabler client (EEC) 20 to provide coordination services for the application clients on UE 102. The server-side ACS functionalities can be added to the edge enabler servers (EESs) 21 or the edge configuration server (ECS) 22, where ACS server 216 at EES 21 may provide coordination services for the EASs 212 associated with the EES, and ACS server 216 at the ECS can provide coordination services for the application servers hosted in the cloud and services hosted in core network 203.

The interactions between the other entities and ACS server 216 or ACS client 215 (as disclosed in the procedures herein, such as FIG. 5-FIG. 11) may be implemented by enhancing the existing reference points defined by 3GPP SA6.

EDGE-1: The enhanced EDGE-1 reference point may enable the interaction between ACS server 216 at EES 21 and ACS client 215 at EEC 20 for notifications and sharing the information obtained by either side.

EDGE-3: Via the enhanced EDGE-3 reference point, ACS server 216 may obtain information from the Edge Application Server(s) 212, which may be used for identifying influencer AS 212, monitoring influencer AS 212, or performing coordination action regarding an influenced AS or influencer AS.

EDGE-4: The enhanced EDGE-4 reference point may enable the interaction between ACS server 216 at ECS 22 and ACS client 215 at EEC 21 for notifications and sharing the information obtained by either side.

EDGE-5: The enhanced EDGE-5 reference point may be used for obtaining information from the Application Client by ACS client 215 at EEC 21, which may be used for identifying influencer AC 210, monitoring influencer AC 210, or performing coordination action regarding an influenced or influencer AC.

EDGE-6: The enhanced EDGE-6 reference point may enable the interaction between ACS server 216 at the EES 21 and ACS server 216 and ECS 22, through which ACS servers 216 may exchange notifications and share information.

EDGE-9: The enhanced EDGE-9 reference point enables the interaction between ACS servers 216 at different EESs 21, through which the ACS servers 216 may exchange notifications and share information.

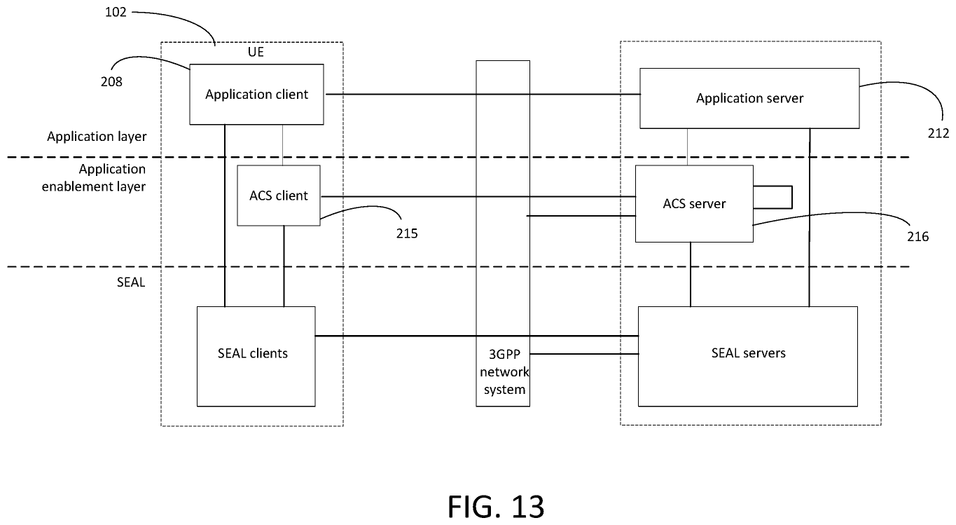

FIG. 13 shows a generic example on top of the SEAL architecture. As shown in FIG. 13, the client-side ACS functionalities may be implemented as a client-side entity on top of the SEAL client in the UE 102 to provide coordination services for the application clients 208 on UE 102. The server-side ACS functionalities may be implemented as a server-side entity on top of the SEAL server to provide coordination services for the application servers 212 that are communicating with the application clients 208 in UE 102.

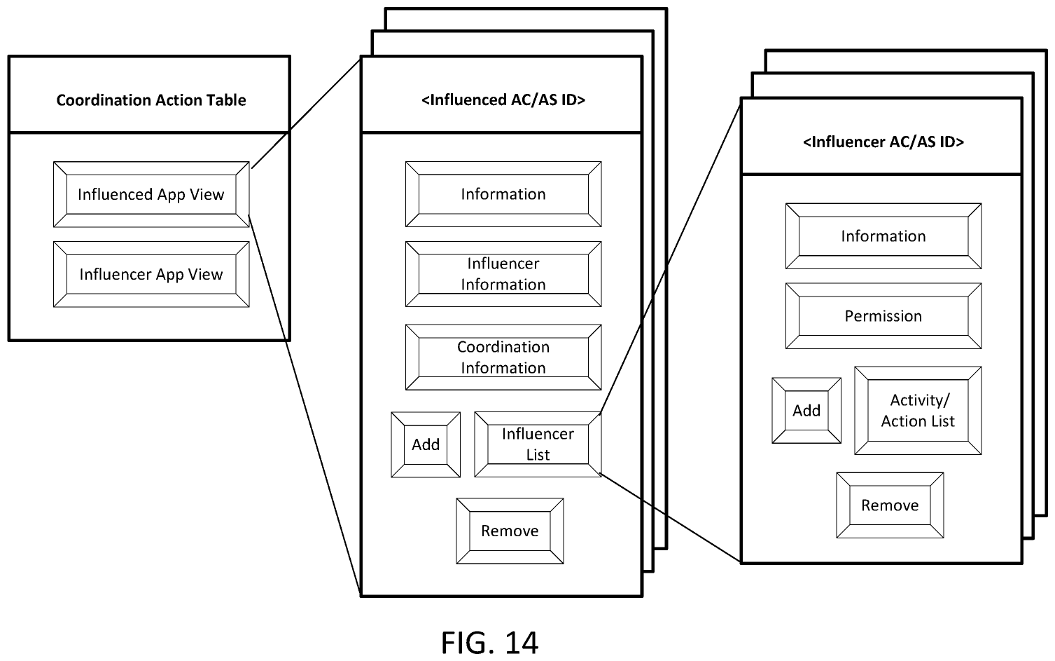

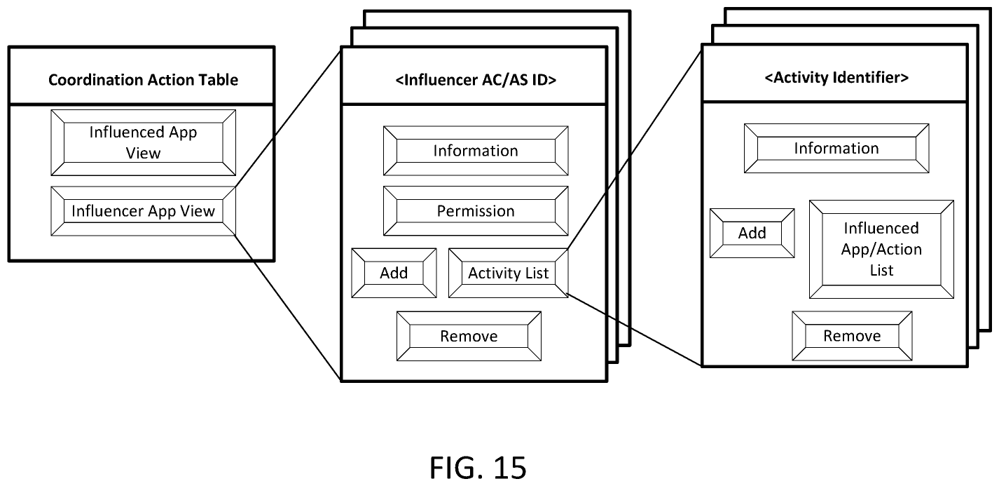

FIG. 14 and FIG. 15 illustrate example graphical user interfaces (GUIs) that may be used by an operator to configure and manage the influenced AC (or AS), influencer application, and coordination action table for the disclosed ACS functionality defined in this paper.

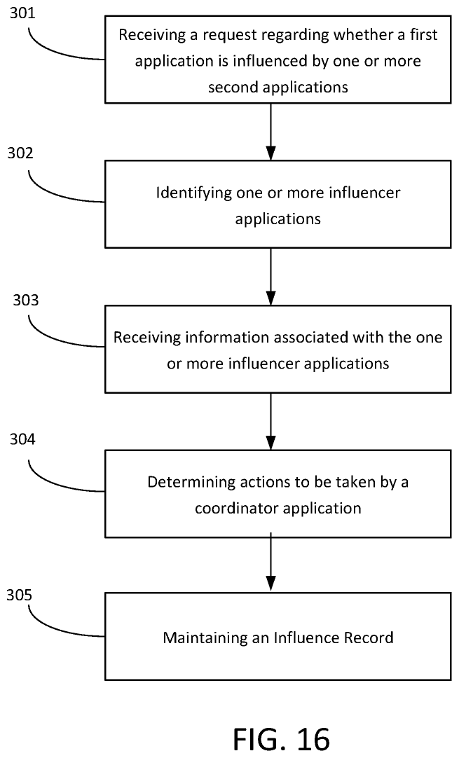

FIG. 16 illustrates an illustrates an exemplary method for enabling an approach in which the coordinator may be fully or partially implemented on the UE. An application coordinator resident on a UE may perform one or more of the following operations to enable awareness among applications resident on or serving the UE and coordinate the activities of these applications. The coordinator may be implemented as a 3GPP SA6 defined application enabler client, EEC, or another functional entity on the UE. An application resident on the UE may be a 3GPP SA6 defined application client (AC).

At step 301, receive a request regarding whether a first application is influenced by one or more second applications. For example, a message may be received from an AC resident on the UE (e.g., the influenced AC) indicating the influenced AC may be interested in knowing how the influenced AC may be potentially affected (or is affected) by the activity of another application (e.g., the influencer AC) that runs on or serves the UE. The influencer AC may be a 3GPP SA6 defined AC resident on the same UE as the influenced AC, a 3GPP SA6 defined edge application server (EAS) or a 3GPP SA6 defined application server (AS). “Being affected” may indicate that the influenced AC should adjust its policy or activities when the influencer application performs a certain action or the status of the influencer application has changed, which may be related to a performance threshold of influenced AC. The message may be an explicit request for application awareness and coordination service, a registration request, a service provisioning request, a configuration request, or other messages that can be shared from the influenced AC to the coordinator.

The message may include the following information: description of the influenced AC, description of the influencer AC that may potentially affect the influenced AC, expected action to be taken by the coordinator, or allowed action to be taken by the coordinator. The description of the influenced AC may include one or more of the following information elements: category or type of the AC, schedule of the AC, required resources, service requirement, service preference, supported actions (e.g., flexible schedule or requirements), or callback address of the influenced AC (name or address of a callback function or resource which may be used by the coordinator to issue a callback or send a notification to the influenced AC). The description of the influencer AC may describe which influencer applications are of interest to the influenced AC, as well as criteria that further qualify specific modules of these influencer applications that are of interest to the influenced AC. The description may include identifier of the corresponding AC or AS, category or type of the application, schedule of the application, required resources, service requirement, service preference, priority, location of the application server instance (e.g., cloud, edge, local), etc. The criteria may include: overlapped schedule between the influencer AC and the influenced AC, resource competition between the influencer and influenced AC (e.g., the corresponding applications have the same resource usage requirements), influencer ACs are of higher priority than the influenced AC, the corresponding EASs may be hosted on the same edge node, influencer application state transitions of interest (e.g., active or inactive), or actions of interest that are performed by the influencer application (e.g., EEC associated with the influencer AC has registered (or deregistered) to specified EES, or the AC has connected to specified EAS, etc.), among other things.

With continued reference to step 301, the expected or allowed action may include: issue a notification or callback to the influenced AC (to have it perform some AC specific action) regarding the influencer application event of interest that has occurred, sending a request to the influenced AC for service requirement adjustment, triggering a request to activate/deactivate/instantiate/suspend the influenced AC or the AS that is serving the influenced AC, triggering an AS relocation, or triggering a grouping operation that includes the influenced AC. The expected action may further include sending a notification to the influencer AC (or AS) (e.g., notifying the influencer AC (or AS) that the influenced AC has been affected by the action or activity of the influencer AC (or AS)), or triggering a request to the influencer AC (or AS) (e.g., a request to reverse the activity of the influencer AC (or AS)), among other things. If the description of the influencer application or expected action are not provided in the message from the influenced AC, they may be inferred by the coordinator based on the description of the influenced AC or local configuration or policies of the coordinator.

At step 302, identify one or more influencer applications. For example, identifying the influencer AC(s) and the corresponding actions to be taken by the coordinator based on the information provided by the influenced AC and other local information available at the coordinator. The local information may include: information of other ACs that are running on the UE, information of the ASs of other applications that are serving the UE, or UE context information.

The information of other ACs that are running on the UE may be AC profile or application characteristics (e.g., expected traffic over time), wherein the information may be provided by the influenced AC to the coordinator. Alternatively, the coordinator may send a (subscription) request to the other ACs for such information.

The information of the ASs of other applications that are serving the UE may be AS (or EAS) profile or application characteristics (e.g., expected traffic over time), wherein the information may be provided by the ASs to the coordinator directly, or by the corresponding influenced AC, or shared by the coordinator implemented at the server side. Alternatively, the coordinator may send a (subscription) request to the other ASs or the coordinator implemented at the server side for such information.

UE context information may include the network conditions (load and congestion), communication access information (e.g. 3GPP access, non-3GPP access), cell type (e.g. macro cell, small cell), user experienced data rate, traffic characteristic of UE (e.g. mobility information (e.g. no mobility, nomadic, spatially restricted mobility, full mobility), location, sensor-level information (e.g. direction, speed, power status, display status, or other sensor information installed in the UE), or application-level information (e.g. foreground applications, running background application, or user settings), among other things. The context information obtained by the coordinator may be shared with the server-side counterpart.

The influencer AC or influencer AS may be identified by performing influencer AC (or AS) discovery based on the specific description (e.g., identifier of the influencer AC (or AS), category or type of the application, schedule of the AC, required resources, priority, etc.); finding influencer ACs (or ASs) that match the implicit description provided by the influenced AC (e.g., finding applications that are sharing the same resources as the influenced application, applications that have similar schedule as the influenced AC, or EASs instantiated at the same edge node as that of the influenced AC); or finding the influencer ACs (or ASs) that may potentially have an effect on the influenced AC, if not specified by the influenced AC (e.g., applications that are competing for resources or communication bandwidth with the influenced AC). The identified influencer application may be an application that is already running on or serving the UE, or it may be an application that is currently not running on or serving the UE. The coordinator may further determine which activities of the identified AC (or AS) are of interest based on the provided description of the influencer application (e.g., adaption of resource usage, changing level of activeness, activation, deactivation, or instantiation). The actions to be taken may be activity-specific, in which for the same influenced AC and the same influencer application, different activities of the influencer application may correspond to different actions. If the expected action is not specified by the influenced AC, a default action may be applied (e.g., sending a notification to the influenced AC).

At step 303, receive information associated with the one or more influencer applications. The information may include identifier of the influencer AC (or AS), category or type of the application, schedule of the AC, required resources, or priority, among other information as disclosed herein.

At step 304, determine actions (e.g., as described with reference to step 301) to be taken by a coordinator.

At step 305, maintain an influence record. For example, maintaining a record of the influenced AC and the identified influencer ACs (or ASs), as well as the corresponding actions to be taken by the coordinator. The recorded influencer applications may include existing AC (or AS) and potential AC (or AS) that may be installed, instantiated, or activated in some way. The record may be shared with the server-side coordinator. The applications with mutual effect may be grouped.

The activities of influencer application may be detected and determined to have an effect on the influenced AC based on criteria that are of interest to the influenced AC, in which the criteria may have been in the message of step 301. The activities of an influencer AC may include: the resource utilization or traffic of the corresponding application has exceeded a certain threshold or dropped below a threshold, the influencer AC has been activated or deactivated, or the AC has connected to specified EAS, among other things. The activities of an influencer AS may include the communication rate between the influencer AS and the UE has changed, the influencer AS has been instantiated/activated/deactivated, or the influencer AS has been relocated, among other things.

The activities of an influencer AC (or AS) may be detected by: receiving a notification from the influencer AC (or AS) indicating their activity or update, monitoring the resource usage or communication rate of the influencer AC (or AS), receiving a registration or provisioning request from the influencer AC (or AS), or receiving a request to perform a certain action on the influencer AC (or AS). the activities of an influencer AS could further be detected by: subscribing to the coordinator on the AS side and receiving notifications regarding influencer AS activities.

When a certain activity of the influencer AC (or AS) has been detected, there may be a joint consideration of the influenced ACs that may be affected, and then determining if an action should be taken and how to coordinate the action(s) or performing the action.

A notification of what action has been performed may be sent to the server-side coordinator. When there are more than one influenced AC that is associated with the influencer AC (or AS), the coordinator may further examine the record to determine if performing the expected action on one influenced AC may affect another influenced AC. If not affecting, the expected action may be performed on each influenced AC. If affecting, the coordinator may selectively perform the expected actions on one or more of the influenced ACs (e.g., based on priority, or random selection, or alternating among group members), adding the effect of these actions to the effect of the influencer AC (or AS), then determine if/what action should be taken for the other influenced ACs. In an example, an influencer application has increased its traffic and resource consumption. Among all the influenced ACs that are competing for the same resource with the influencer application, the coordinator may send a request to scale back resource usage to some of them while performing no action on the others.

If the action is to send a notification to the influenced AC, the coordinator will determine if the notification should be sent based on the notification setting (e.g., frequency limit). The coordinator may further predict if there is any cascaded effect when performing an action and determine the next action proactively.

Below is an example approach for the coordinator fully or partially implemented in the network. An application coordinator resident in the core network or in an edge node (e.g., cloud node) in the network that performs one or more of the following operations to enable awareness among applications serving the same UE and coordinate the activities of these applications.

The coordinator may be implemented as a 3GPP SA6 defined application enabler server, EES, or another functional entity in the core network or edge node. An application resident on the UE may be a 3GPP SA6 defined application client (AC).

A message may be received from an AS (the influenced AS) indicating it is interested in knowing how it may be potentially affected by the activity of another application (the influencer application) that is or will be serving the same UE. The influencer application may be a 3GPP SA6 defined application client (AC), a 3GPP SA6 defined edge application server (EAS) or a 3GPP SA6 defined application server (AS). “Being affected” may mean that the influenced AS may need to adjust its policy or activities when the influencer application performs a certain action or the status of the influencer application has changed. The message may be an explicit request for application awareness and coordination service, a registration request, a service provisioning request, a configuration request, or other messages that may be shared from the influenced AS to the coordinator. The message may include the following information: description of the influenced AS, description of the influencer application that may potentially affect the influenced AS, allowed action to be taken by the coordinator, or expected action to be taken by the coordinator.

The description of the influenced AS may include one or more of the following information elements: category or type of the AS, schedule of the AS, required resources, service requirement and preference, or supported actions (e.g., flexible schedule or requirements). The description of the influencer application may describe which factor of the influencer application is of interest to the influenced AS or how activities of the influencer application may potentially have an effect on the influenced AS, which may include one or more of the following information elements: identifier of the corresponding AC or AS, category or type of the application, schedule of the application, required resources, service requirement and preference, priority, location of the application server instance (e.g., cloud, edge, local), implicit description based on the above factors (e.g., applications with overlapping schedule with the influenced AS, applications that are using the same resources as the influenced AS, applications with higher priority than the influenced AS, or applications with AS instantiated at the same edge node as the influenced AS).

The expected or allowed action may include: notifying the influenced AS of when and how it would be affected (and by which application), triggering a service requirement adjustment, triggering a request to activate/deactivate/instantiate/suspend the influenced AS or the AC that is being served by the influenced AS, triggering an AS relocation, or triggering a grouping operation that includes the influenced AS.

The influencer application(s) may be identified and the corresponding actions to be taken may be identified by the coordinator based on the information provided by the influenced AS and other local information available at the coordinator. Local information may include information of ASs of other applications that are serving the same UE as the influenced AS (e.g., AS or EAS profile, application characteristics (e.g., expected traffic over time)) where the information is provided by the AS to the coordinator. Alternatively, the coordinator may send a (subscription) request to the other AS for such information.

Local information may include information of the ACs of other applications that are hosted on the same UE (e.g., AC profile, application characteristics (e.g., expected traffic over time)) where the information is provided by the AC to the coordinator directly, or by the corresponding AS, or shared by the coordinator implemented at the UE side. Alternatively, the coordinator may send a (subscription) request to the other AC or the coordinator implemented at the UE side for such information. Local information may include UE context information, such as the network conditions (load and congestion), access information (e.g., 3GPP access, non-3GPP access), cell type (e.g., macro cell, small cell), user experienced data rate, traffic characteristic of UE (e.g., mobility information (e.g., no mobility, nomadic, spatially restricted mobility, full mobility), location, sensor-level information (e.g., direction, speed, power status, display status, other sensor information installed in the UE), application-level information (e.g., foreground applications, running background application, and user settings). The context information may be obtained from the UE-side counterpart.

The influencer AC or AS may be identified by: performing AC (or AS) discovery based on the specific description (e.g., identifier of the AC (or AS), category or type of the application, schedule of the AS, required resources, priority, etc.); finding ACs (or ASs) that match the implicit description provided by the influenced AS (e.g., finding applications that are sharing the same resources as the influenced application, applications that have similar schedule as the influenced application, applications with EASs instantiated at the same edge node as the influenced AS); or finding all ACs (or ASs) that may potentially have an effect on the influenced application, if not specified by the influenced AS (e.g., applications that are competing for resources or communication bandwidth with the influenced application).

The identified influencer application may be an application that is already serving the UE, or it may be an application that has not been instantiated or activated. The coordinator may further determine which activities of the identified AC (or AS) are of interest based on the provided description of the influencer application (e.g., adaption of resource usage, changing level of activeness, activation, deactivation, instantiation). The actions to be taken may be activity-specific (for the same influenced AS and the same influencer application, different activities of the influencer application may correspond to different actions).

A record of the influenced AS and the identified influencer applications (or ASs) may be maintained (e.g., as disclosed in the Tables herein), as well as the corresponding actions to be taken by the coordinator, such as the recorded influencer applications may include existing AC (or AS) and potential AC (or AS) that will be installed/instantiated/activated; the record may be shared with the UE-side coordinator; or applications with mutual effect may be grouped.

The activities of the identified influencer application may be detected that may have an effect on the influenced AS. The activities of an influencer AC may include: the resource utilization/traffic of the corresponding application has exceeded a certain threshold or dropped below a threshold, the influencer AC has been activated or deactivated, etc.

The activities of an influencer AS may include: the communication rate between the influencer AS and the UE has changed, the influencer AS has been instantiated/activated/deactivated, the influencer AS has been relocated, etc. The activities of an influencer AC (or AS) may be detected by: receiving a notification from the influencer AC (or AS) indicating their activity or update, monitoring the resource usage or communication rate of the influencer AC (or AS), receiving a registration or provisioning request from the influencer AC (or AS), receiving a request to perform a certain action on the influencer AC (or AS).

The activities of an influencer AC could further be detected by: subscribing to the coordinator on the UE side and receiving notifications regarding influencer AC activities.

A certain activity of the influencer AC (or AS) may be detected, jointly considering the influenced ASs that may be affected, determining if an action should be taken and what action should be taken, and performing the action. A notification of what action has been performed is sent to the UE-side coordinator. There are more than one influenced AC that is associated with the influencer AC (or AS), the coordinator may further examine the record to determine if performing the expected action on one influenced AC may affect another influenced AC. If not, the expected action will be performed on each influenced AS. If so, the coordinator will selectively perform the expected actions on one or more of the influenced ASs (e.g., based on priority, or random selection, or alternating among group members), adding the effect of these actions to the effect of the influencer AC (or AS), then determine if/what action should be taken for the other influenced ASs. (For example, an influencer application has increased its traffic and resource consumption. Among all the applications that are competing the same resource with the influencer application, the coordinator may send a request to scale back resource usage to some of them while performing no action on the others.)

If the action is to send a notification to the influenced AS, the coordinator will determine if the notification should be sent based on the notification setting (e.g., frequency limit). The coordinator may further predict if there is any cascaded effect when performing an action and determine the next action proactively.

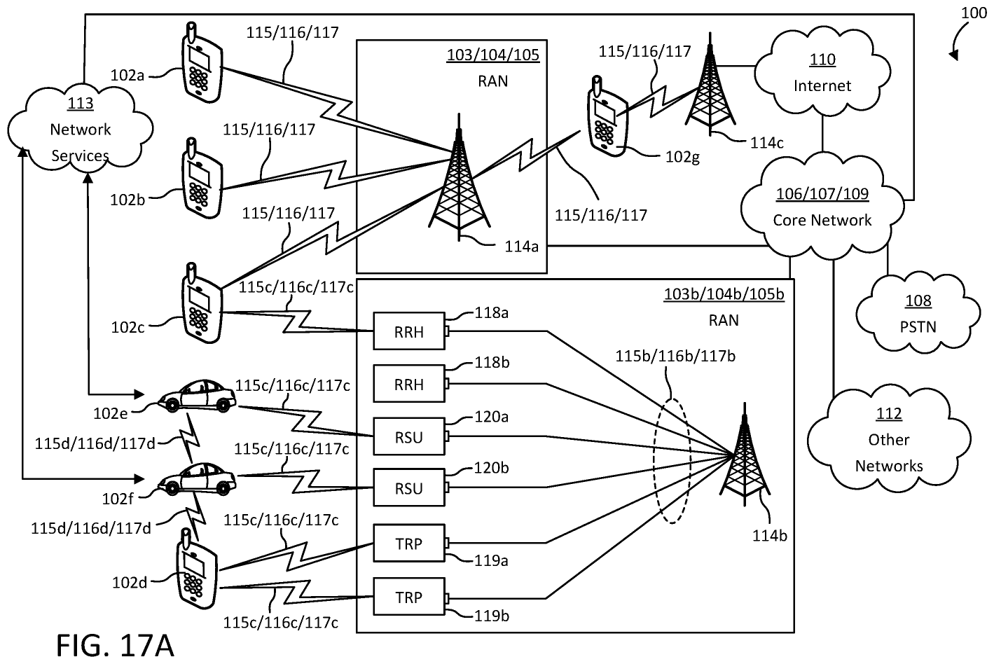

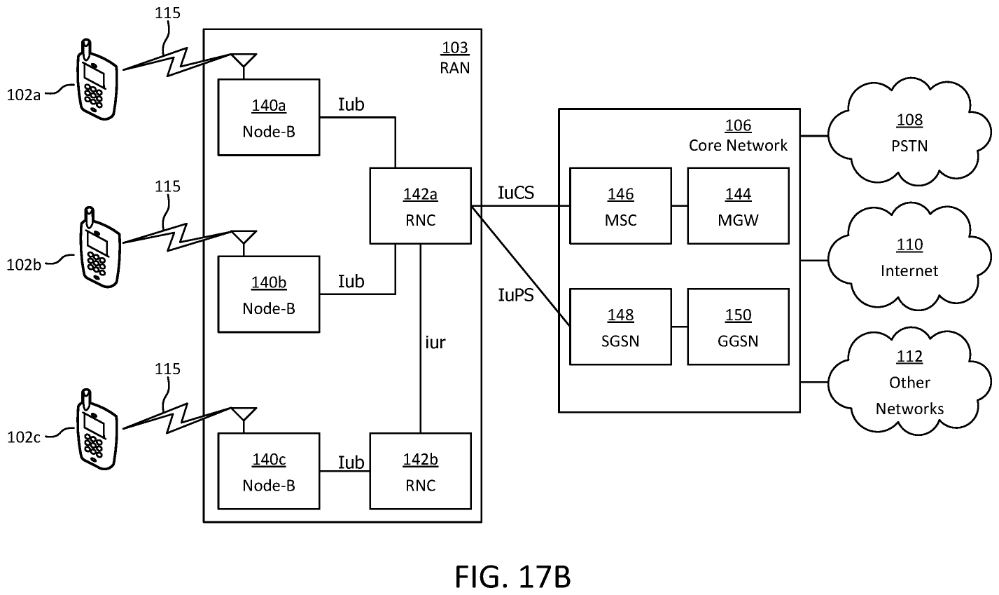

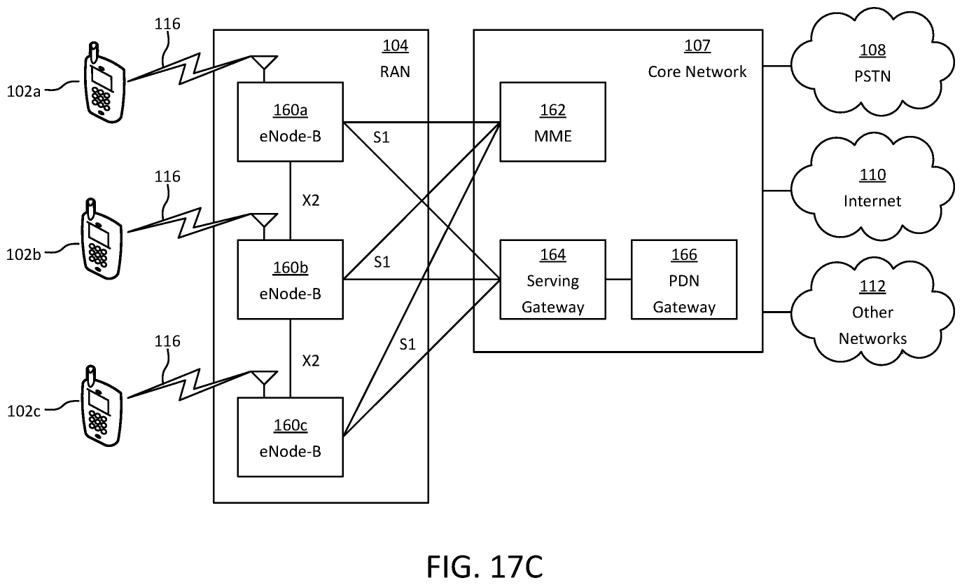

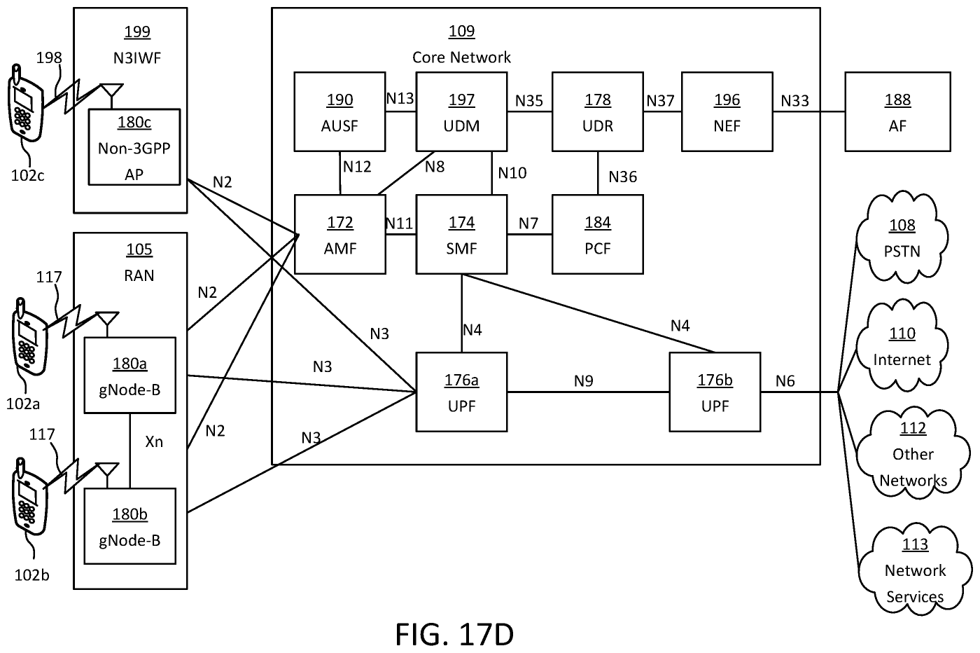

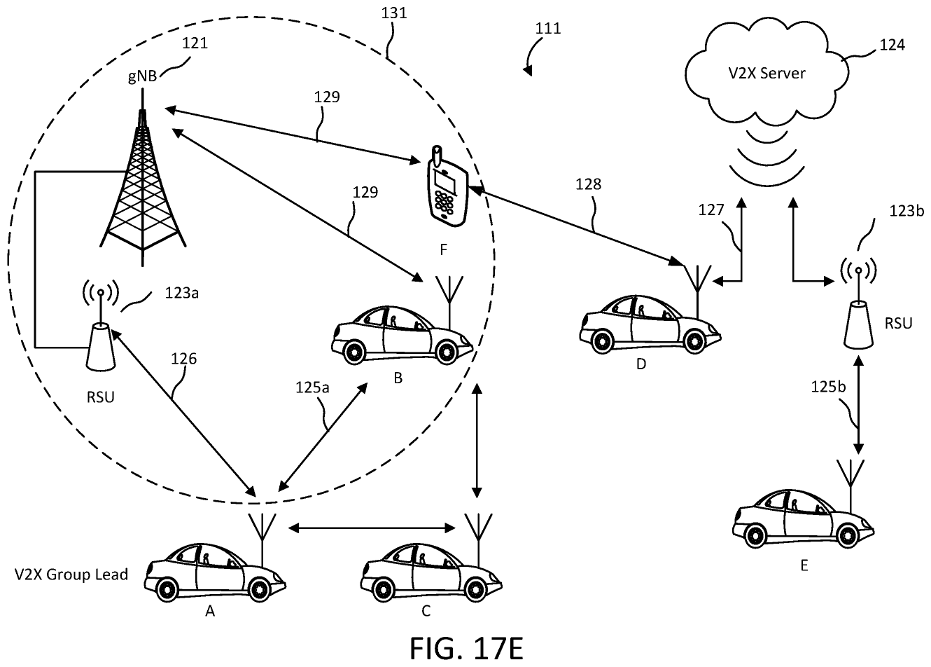

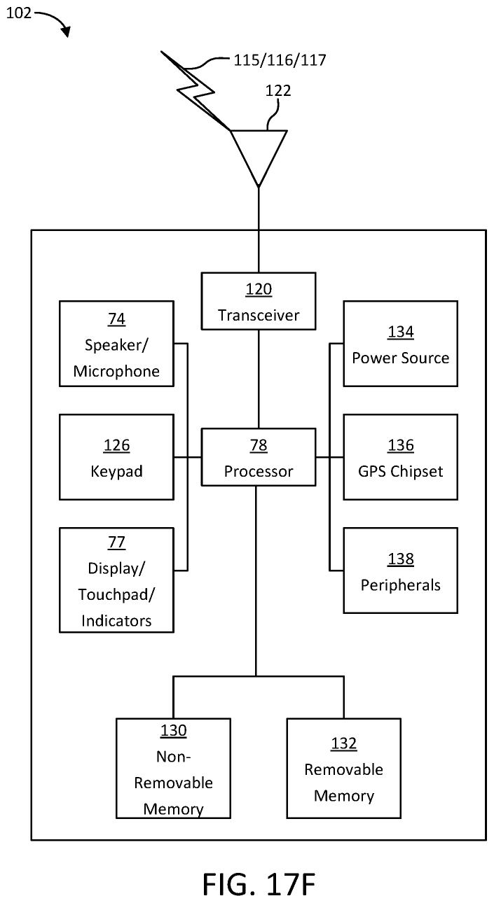

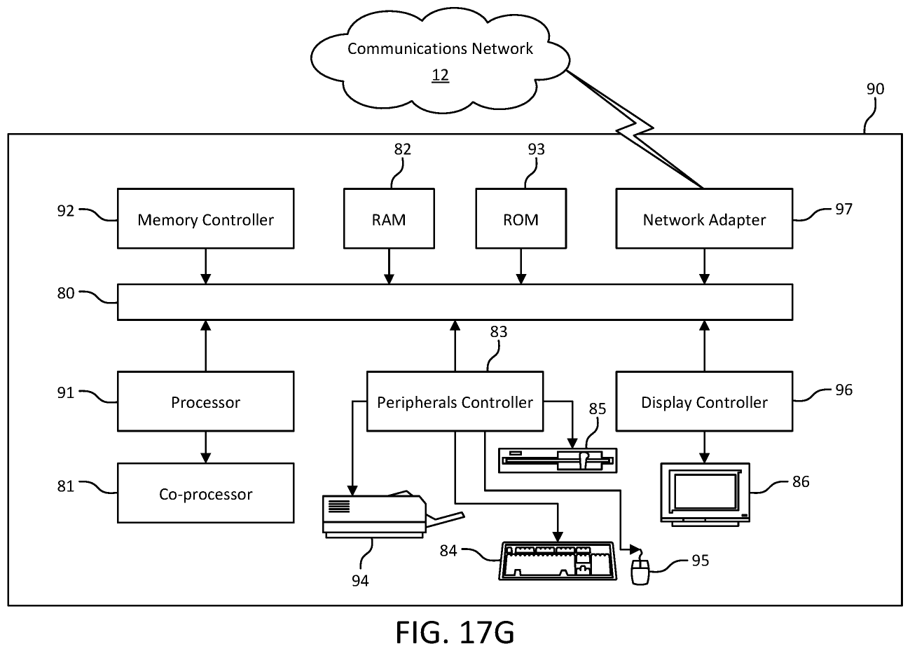

It is understood that the entities performing the steps illustrated herein, such as FIG. 5-FIG. 11, may be logical entities. The steps may be stored in a memory of, and executing on a processor of, a device, server, or computer system such as those illustrated in FIG. 17F or FIG. 17G. Skipping steps, combining steps, or adding steps between exemplary methods disclosed herein (e.g., FIG. 5-FIG. 11) is contemplated.

Table 6 provides abbreviations and definitions. Table 7 provides terms and definitions.

TABLE 6
Abbreviations and Definitions

| Abbreviations | Definitions |
|---|---|
| 5GC | 5G Core Network |
| API | Application Programming Interface |
| AS | Application Server |
| AC | Application Client |
| ACS | Application Coordination Service |
| CN | Core Network |
| EAS | Edge Application Server |
| ECS | Edge Configuration Server |
| EES | Edge Enabler Server |
| EEC | Edge Enabler Client |
| GUI | Graphical User Interface |
| SEAL | Service Enabler Architecture Layer |
| SL | Service Layer |
| UE | User Equipment |
| URI | Universal Resource Identifier |

TABLE 7
Terms

| Term | Definitions |
|---|---|
| Application client | Application software resident on a UE performing a |
| | client function. |
| Application server | Application software resident in the cloud or on an |
| | edge node in the network performing a server |
| | function. |
| Edge computing | A network architecture concept that enables cloud |
| | computing capabilities and service environments to |
| | be deployed close to endpoint devices or UEs. |
| Edge application | An application client interfacing to an application |
| client | server resident on an edge node in the network. |
| Edge application | An application server resident on an edge node in |
| server | the network. |
| Influenced | The application or its client (or server) that is |
| application/AC (or | initiating the request for application coordination |
| AS) | service or receiving the offer of application |
| | coordination service if the application client (or |
| | server) may be potentially affected by another |
| | application. |
| Influencer | The application or its client (or server) that could |
| application/AC (or | potentially affect the influenced AC (or AS). The |
| AS) | influencer application may be an application client |
| | resident on the same UE as the influenced AC, or an |
| | application server. |
| Application | The functionalities disclosed to coordinate the |
| coordination | activities of applications where the status or activity |
| service (ACS) | of one application (influencer application) may have |
| | an effect on the policy or behavior of another |
| | application (influenced AC (or AS)). |
| Coordinator | A coordinator is the entity that is providing the |
| | application coordination service, such as an ACS |
| | client or ACS server. |

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 6 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

FIG. 17A illustrates an example communications system 100 in which the methods and apparatuses of enabling awareness and coordination among applications, such as the systems and methods illustrated in FIG. 4 through FIG. 15 described and claimed herein may be used. The communications system 100 may include wireless transmit/receive units (WTRUs) 102a, 102b, 102c, 102d, 102e, 102f, or 102g (which generally or collectively may be referred to as WTRU 102 or WTRUs 102). The communications system 100 may include, a radio access network (RAN) 103/104/105/103b/104b/105b, a core network 106/107/109, a public switched telephone network (PSTN) 108, the Internet 110, other networks 112, and Network Services 113. Network Services 113 may include, for example, a V2X server, V2X functions, a ProSe server, ProSe functions, IoT services, video streaming, or edge computing, etc.

It will be appreciated that the concepts disclosed herein may be used with any number of WTRUs, base stations, networks, or network elements. Each of the WTRUs 102a, 102b, 102c, 102d, 102e, 102f, or 102g may be any type of apparatus or device configured to operate or communicate in a wireless environment. Although each WTRU 102a, 102b, 102c, 102d, 102e, 102f, or 102g may be depicted in FIG. 17A, FIG. 17B, FIG. 17C, FIG. 17D, FIG. 17E, or FIG. 17F as a hand-held wireless communications apparatus, it is understood that with the wide variety of use cases contemplated for 5G wireless communications, each WTRU may comprise or be embodied in any type of apparatus or device configured to transmit or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus, truck, train, or airplane, and the like.

The communications system 100 may also include a base station 114a and a base station 114b. In the example of FIG. 17A, each base stations 114a and 114b is depicted as a single element. In practice, the base stations 114a and 114b may include any number of interconnected base stations or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, or the other networks 112. Similarly, base station 114b may be any type of device configured to wiredly or wirelessly interface with at least one of the Remote Radio Heads (RRHs) 118a, 118b, Transmission and Reception Points (TRPs) 119a, 119b, or Roadside Units (RSUs) 120a and 120b to facilitate access to one or more communication networks, such as the core network 106/107/109, the Internet 110, other networks 112, or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, or other networks 112

TRPs 119a, 119b may be any type of device configured to wirelessly interface with at least one of the WTRU 102d, to facilitate access to one or more communication networks, such as the core network 106/107/109, the Internet 110, Network Services 113, or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations or network elements (not shown), such as a Base Station Controller (BSC), a Radio Network Controller (RNC), relay nodes, etc. Similarly, the base station 114b may be part of the RAN 103b/104b/105b, which may also include other base stations or network elements (not shown), such as a BSC, a RNC, relay nodes, etc. The base station 114a may be configured to transmit or receive wireless signals within a particular geographic region, which may be referred to as a cell (not shown). Similarly, the base station 114b may be configured to transmit or receive wired or wireless signals within a particular geographic region, which may be referred to as a cell (not shown) for methods, systems, and devices of enabling awareness and coordination among applications, as disclosed herein. Similarly, the base station 114b may be configured to transmit or receive wired or wireless signals within a particular geographic region, which may be referred to as a cell (not shown). The cell may further be divided into cell sectors. For example, the cell associated with the base station 114a may be divided into three sectors. Thus, in an example, the base station 114a may include three transceivers, e.g., one for each sector of the cell. In an example, the base station 114a may employ multiple-input multiple output (MIMO) technology and, therefore, may utilize multiple transceivers for each sector of the cell.

The base stations 114a may communicate with one or more of the WTRUs 102a, 102b, 102c, or 102g over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, or RSUs 120a, 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c,102d, 102e, or 102f may communicate with one another over an air interface 115d/116d/117d, such as Sidelink communication, which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) or Evolved HSPA (HSPA+). HSPA may include High-Speed Downlink Packet Access (HSDPA) or High-Speed Uplink Packet Access (HSUPA).

In an example, the base station 114a and the WTRUs 102a, 102b, 102c, or RRHs 118a, 118b, TRPs 119a, 119b, or RSUs 120a, 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) or LTE-Advanced (LTE-A). In the future, the air interface 115/116/117 or 115c/116c/117c may implement 3GPP NR technology. The LTE and LTE-A technology may include LTE D2D and V2X technologies and interfaces (such as Sidelink communications, etc.). Similarly, the 3GPP NR technology includes NR V2X technologies and interface (such as Sidelink communications, etc.).

The base station 114a in the RAN 103/104/105 and the WTRUs 102a, 102b, 102c, and 102g or RRHs 118a, 118b, TRPs 119a, 119b or RSUs 120a, 120b in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 17A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like, for implementing the methods, systems, and devices of enabling awareness and coordination among applications, as disclosed herein. In an example, the base station 114c and the WTRUs 102, e.g., WTRU 102e, may implement a radio technology such as IEEE 802.11 to establish a wireless local area network (WLAN). similarly, the base station 114c and the WTRUs 102d, may implement a radio technology such as IEEE 802.15 to establish a wireless personal area network (WPAN). In yet another example, the base station 114c and the WTRUs 102, e.g., WTRU 102e, may utilize a cellular-based RAT (e.g., WCDMA, CDMA2000, GSM, LTE, LTE-A, NR, etc.) to establish a picocell or femtocell. As shown in FIG. 17A, the base station 114c may have a direct connection to the Internet 110. Thus, the base station 114c may not be required to access the Internet 110 via the core network 106/107/109.

The RAN 103/104/105 or RAN 103b/104b/105b may be in communication with the core network 106/107/109, which may be any type of network configured to provide voice, data, messaging, authorization and authentication, applications, or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, packet data network connectivity, Ethernet connectivity, video distribution, etc., or perform high-level security functions, such as user authentication.

Although not shown in FIG. 17A, it will be appreciated that the RAN 103/104/105 or RAN 103b/104b/105b or the core network 106/107/109 may be in direct or indirect communication with other RANs that employ the same RAT as the RAN 103/104/105 or RAN 103b/104b/105b or a different RAT. For example, in addition to being connected to the RAN 103/104/105 or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102a, 102b, 102c, 102d, 102e to access the PSTN 108, the Internet 110, or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned or operated by other service providers. For example, the networks 112 may include any type of packet data network (e.g., an IEEE 802.3 Ethernet network) or another core network connected to one or more RANs, which may employ the same RAT as the RAN 103/104/105 or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links for implementing methods, systems, and devices of enabling awareness and coordination among applications, as disclosed herein. For example, the WTRU 102g shown in FIG. 17A may be configured to communicate with the base station 114a, which may employ a cellular-based radio technology, and with the base station 114c, which may employ an IEEE 802 radio technology.

Although not shown in FIG. 17A, it will be appreciated that a User Equipment may make a wired connection to a gateway. The gateway maybe a Residential Gateway (RG). The RG may provide connectivity to a Core Network 106/107/109. It will be appreciated that much of the subject matter included herein may equally apply to UEs that are WTRUs and UEs that use a wired connection to connect with a network. For example, the subject matter that applies to the wireless interfaces 115, 116, 117 and 115c/116c/117c may equally apply to a wired connection.

FIG. 17B is a system diagram of an example RAN 103 and core network 106 that may implement methods, systems, and devices of enabling awareness and coordination among applications, as disclosed herein. As noted above, the RAN 103 may employ a UTRA radio technology to communicate with the WTRUs 102a, 102b, and 102c over the air interface 115. The RAN 103 may also be in communication with the core network 106. As shown in FIG. 17B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 17B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142aand 142b may be configured to control the respective Node-Bs 140a, 140b, and 140c to which it is connected. In addition, each of the RNCs 142aand 142b may be configured to carry out or support other functionality, such as outer loop power control, load control, admission control, packet scheduling, handover control, macro-diversity, security functions, data encryption, and the like.

The core network 106 shown in FIG. 17B may include a media gateway (MGW) 144, a Mobile Switching Center (MSC) 146, a Serving GPRS Support Node (SGSN) 148, or a Gateway GPRS Support Node (GGSN) 150. While each of the foregoing elements are depicted as part of the core network 106, it will be appreciated that any one of these elements may be owned or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned or operated by other service providers.

FIG. 17C is a system diagram of an example RAN 104 and core network 107 that may implement methods, systems, and devices of enabling awareness and coordination among applications, as disclosed herein. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink or downlink, and the like. As shown in FIG. 17C, the eNode-Bs 160a, 160b, and 160c may communicate with one another over an X2 interface.

The core network 107 shown in FIG. 17C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned or operated by other service providers.

FIG. 17D is a system diagram of an example RAN 105 and core network 109 that may implement methods, systems, and devices of enabling awareness and coordination among applications, as disclosed herein. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink or downlink, and the like. As shown in FIG. 17D, the gNode-Bs 180a and 180b may communicate with one another over an Xn interface, for example.

The core network 109 shown in FIG. 17D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless or network communications or a computer system, such as system 90 illustrated in FIG. 17G.

In the example of FIG. 17D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned or operated by an entity other than the core network operator. It will also be appreciated that a 5G core network may not consist of all of these elements, may consist of additional elements, and may consist of multiple instances of each of these elements. FIG. 17D shows that network functions directly connect with one another, however, it should be appreciated that they may communicate via routing agents such as a diameter routing agent or message buses.

In the example of FIG. 17D, connectivity between network functions is achieved via a set of interfaces, or reference points. It will be appreciated that network functions may be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 17D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 17D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect with network functions, so that network function can add to, read from, and modify the data that is in the repository. For example, the UDR 178 may connect with the PCF 184 via an N36 interface. Similarly, the UDR 178 may connect with the NEF 196 via an N37 interface, and the UDR 178 may connect with the UDM 197 via an N35 interface.

The UDM 197 may serve as an interface between the UDR 178 and other network functions. The UDM 197 may authorize network functions to access of the UDR 178. For example, the UDM 197 may connect with the AMF 172 via an N8 interface, the UDM 197 may connect with the SMF 174 via an N10 interface. Similarly, the UDM 197 may connect with the AUSF 190 via an N13 interface. The UDR 178 and UDM 197 may be tightly integrated.

The AUSF 190 performs authentication related operations and connect with the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect with an AF 188 via an N33 interface and it may connect with other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that may be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g. in the areas of functionality, performance and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 17D, in a network slicing scenario, a WTRU 102a, 102b, or 102c may connect with an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned or operated by other service providers.

The core network entities described herein and illustrated in FIG. 17A, FIG. 17C, FIG. 17D, or FIG. 17E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIG. 17A, FIG. 17B, FIG. 17C, FIG. 17D, or FIG. 17E are provided by way of example only, and it is understood that the subject matter disclosed and claimed herein may be embodied or implemented in any similar communication system, whether presently defined or defined in the future.

FIG. 17E illustrates an example communications system 111 in which the systems, methods, apparatuses that implement enabling awareness and coordination among applications, described herein, may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 17E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 17E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 17F is a block diagram of an example apparatus or device WTRU 102 that may be configured for wireless communications and operations in accordance with the systems, methods, and apparatuses that implement enabling awareness and coordination among applications, described herein, such as a WTRU 102 of FIG. 17A, FIG. 17B, FIG. 17C, FIG. 17D, or FIG. 17E, or FIG. 4-FIG. 13. As shown in FIG. 17F, the example WTRU 102 may include a processor 78, a transceiver 120, a transmit/receive element 122, a speaker/microphone 74, a keypad 126, a display/touchpad/indicators 77, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 17F and may be an exemplary implementation that performs the disclosed systems and methods for enabling awareness and coordination among applications described herein.

The processor 78 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 78 may perform signal coding, data processing, power control, input/output processing, or any other functionality that enables the WTRU 102 to operate in a wireless environment. The processor 78 may be coupled to the transceiver 120, which may be coupled to the transmit/receive element 122. While FIG. 17F depicts the processor 78 and the transceiver 120 as separate components, it will be appreciated that the processor 78 and the transceiver 120 may be integrated together in an electronic package or chip.

The transmit/receive element 122 of a UE may be configured to transmit signals to, or receive signals from, a base station (e.g., the base station 114a of FIG. 17A) over the air interface 115/116/117 or another UE over the air interface 115d/116d/117d. For example, the transmit/receive element 122 may be an antenna configured to transmit or receive RF signals. The transmit/receive element 122 may be an emitter/detector configured to transmit or receive IR, UV, or visible light signals, for example. The transmit/receive element 122 may be configured to transmit and receive both RF and light signals. It will be appreciated that the transmit/receive element 122 may be configured to transmit or receive any combination of wireless or wired signals.

In addition, although the transmit/receive element 122 is depicted in FIG. 17F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 78 of the WTRU 102 may be coupled to, and may receive user input data from, the speaker/microphone 74, the keypad 126, or the display/touchpad/indicators 77 (e.g., a liquid crystal display (LCD) display unit or organic light-emitting diode (OLED) display unit. The processor 78 may also output user data to the speaker/microphone 74, the keypad 126, or the display/touchpad/indicators 77. In addition, the processor 78 may access information from, and store data in, any type of suitable memory, such as the non-removable memory 130 or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 78 may access information from, and store data in, memory that is not physically located on the WTRU 102, such as on a server that is hosted in the cloud or in an edge computing platform or in a home computer (not shown). The processor 78 may be configured to control lighting patterns, images, or colors on the display or indicators 77 in response to whether the setup of the enabling awareness and coordination in some of the examples described herein are successful or unsuccessful, or otherwise indicate a status of enabling awareness and coordination among applications and associated components. The control lighting patterns, images, or colors on the display or indicators 77 may be reflective of the status of any of the method flows or components in the FIG.'s illustrated or discussed herein (e.g., FIG. 5-FIG. 2611 etc.). Disclosed herein are messages and procedures of enabling awareness and coordination among applications. The messages and procedures may be extended to provide interface/API for users to request resources via an input source (e.g., speaker/microphone 74, keypad 126, or display/touchpad/indicators 77) and request, configure, or query enabling awareness and coordination among applications related information, among other things that may be displayed on display 77.

The processor 78 may receive power from the power source 134 and may be configured to distribute or control the power to the other components in the WTRU 102. The power source 134 may be any suitable device for powering the WTRU 102. For example, the power source 134 may include one or more dry cell batteries, solar cells, fuel cells, and the like.

The processor 78 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) or determine its location based on the timing of the signals being received from two or more nearby base stations. It will be appreciated that the WTRU 102 may acquire location information by way of any suitable location-determination method.

The processor 78 may further be coupled to other peripherals 138, which may include one or more software or hardware modules that provide additional features, functionality, or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect with other components, modules, or systems of such apparatuses or devices via one or more interconnect interfaces, such as an interconnect interface that may comprise one of the peripherals 138.

FIG. 17G is a block diagram of an exemplary computing system 90 in which one or more apparatuses of the communications networks illustrated in FIG. 17A, FIG. 17C, FIG. 17D and FIG. 17E as well as enabling awareness and coordination among applications, such as the systems and methods illustrated in FIG. 4 through FIG. 15 described and claimed herein may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, or any other functionality that enables the computing system 90 to operate in a communications network. Coprocessor 81 is an optional processor, distinct from main processor 91, that may perform additional functions or assist processor 91. Processor 91 or coprocessor 81 may receive, generate, and process data related to the methods and apparatuses disclosed herein for enabling awareness and coordination among applications, such as receiving message of different types.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally include stored data that cannot easily be modified. Data stored in RAM 82 may be read or changed by processor 91 or other hardware devices. Access to RAM 82 or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may include peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may include communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIG. 17A, FIG. 17B, FIG. 17C, FIG. 17D, or FIG. 17E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 78 or 91, cause the processor to perform or implement the systems, methods and processes described herein. Specifically, any of the steps, operations, or functions described herein may be implemented in the form of such computer executable instructions, executing on the processor of an apparatus or computing system configured for wireless or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

In describing preferred methods, systems, or apparatuses of the subject matter of the present disclosure—enabling awareness and coordination among applications—as illustrated in the Figures, specific terminology is employed for the sake of clarity. The claimed subject matter, however, is not intended to be limited to the specific terminology so selected.

The various techniques described herein may be implemented in connection with hardware, firmware, software or, where appropriate, combinations thereof. Such hardware, firmware, and software may reside in apparatuses located at various nodes of a communication network. The apparatuses may operate singly or in combination with each other to effectuate the methods described herein. As used herein, the terms “apparatus,” “network apparatus,” “node,” “device,” “network node,” or the like may be used interchangeably. In addition, the use of the word “or” is generally used inclusively unless otherwise provided herein.

This written description uses examples for the disclosed subject matter, including the best mode, and also to enable any person skilled in the art to practice the disclosed subject matter, including making and using any devices or systems and performing any incorporated methods. The disclosed subject matter may include other examples that occur to those skilled in the art (e.g., skipping steps, combining steps, or adding steps between exemplary methods disclosed herein).

Methods, systems, and apparatuses, among other things, as described herein may provide for enabling awareness and coordination among applications. A method, system, computer readable storage medium, or apparatus provides for receiving a message from an influenced application, the message indicating the influenced application may be affected by an activity of one or more influencer applications that serves a user equipment (UE); wherein the message comprises first information, the first information comprising a description of the influenced application, a description of the one or more influencer applications, an expected action to be taken by a coordinator service, or an allowed action to be taken by the coordinator service; identifying a first influencer application of the one or more influencer applications; receiving second information associated with the first influencer application; and based on the second information, determining actions to be taken by the coordinator service. Methods, systems, and apparatuses, among other things, as described herein may provide for maintaining an influence record of the influenced application, wherein the influence record comprises an operation of the first influencer application and an action to be taken by the coordinator service. All combinations in this paragraph and the below paragraphs (including the removal or addition of steps) are contemplated in a manner that may be consistent with the other portions of the detailed description.

Methods, systems, and apparatuses, among other things, as described herein may provide for enabling awareness and coordination among applications. A method, system, computer readable storage medium, or apparatus provides for receiving coordination service request; processing the service request; and based on the processing of the service request, sending a response. The coordination service request may be an indication for the request in a message sent to an ACS client, the message sent comprises a registration request, a service provisioning request, or a configuration request. The coordination service request coordination service request initiated by influenced AC. A method, system, computer readable storage medium, or apparatus provides for send a coordination service request, which may be processed by an ACS client; and in response to the coordination service request, receiving a response. As disclosed herein, it is contemplated that the methods herein associated with the application client may apply to application server, the application server may application client, and application server or application client may apply to application. All combinations in this paragraph and the below paragraph (including the removal or addition of steps) are contemplated in a manner that may be consistent with the other portions of the detailed description.

A method, system, computer readable storage medium, or apparatus provides for receiving a message indicating a request for how an influenced application (e.g., an application operating on a UE (e.g., AC) or on a server (e.g., AS)) may be affected by an activity of one or more influencer applications that serves a user equipment (UE); wherein the message comprises first information, the first information comprising a description of the influenced application, a description of the one or more influencer applications, an expected action to be taken by a coordinator application, or an allowed action to be taken by the coordinator application; identifying a first influencer application of the one or more influencer applications; receiving second information associated with the first influencer application; based on the second information, determining actions to be taken by the coordinator application; and maintaining an influence record of the influenced application, wherein the influence record comprises an operation of the first influencer application and an action taken by the coordinator application. The first influencer application may operate on the UE or a server communicatively connected with the UE. A method, system, computer readable storage medium, or apparatus provides detecting, based on a criteria, one or more actions of the first influencer application that has an effect on the influenced application. The second information may include context information of the UE, wherein the context information comprises data rate, sensor-level information, or communication access information. The second information may include application characteristics of the first influencer application, wherein the characteristics of the first influencer application comprises expected traffic over a period. The description of the one or more influencer applications may include a first identifier of the first influencer application when a threshold has been met that indicates influencing of an influenced application or a second identifier for indicating an influencer application server associated with the one or more influencer applications. The description of the influenced application may include a schedule of an application client (AC) associated with the influenced application or callback address of the influenced AC. All combinations in this paragraph (including the removal or addition of steps) are contemplated in a manner that is consistent with the other portions of the detailed description.

What is claimed:

1. A method comprising:
receiving a message from an influenced application, the message indicating the influenced application may be affected by an activity of one or more influencer applications that serves a user equipment (UE);
wherein the message comprises first information, the first information comprising a description of the influenced application, a description of the one or more influencer applications, an expected action to be taken by a coordinator service, or an allowed action to be taken by the coordinator service;
identifying a first influencer application of the one or more influencer applications;
receiving second information associated with the first influencer application; and
based on the second information, determining actions to be taken by the coordinator service.

2. The method of claim 1, further comprising maintaining an influence record of the influenced application, wherein the influence record comprises an operation of the first influencer application and an action to be taken by the coordinator service.

3. The method of claim 1, wherein the description of the influenced application comprises a schedule of an application client (AC) associated with the influenced application or callback address of the influenced AC.

4. The method of claim 1, wherein the description of the one or more influencer applications comprises a first identifier of the first influencer application when a threshold has been met that indicates influencing of an influenced application or a second identifier for indicating an influencer application server associated with the one or more influencer applications.

5. The method of claim 1, wherein the second information comprises application characteristics of the first influencer application, wherein the characteristics of the first influencer application comprises expected traffic over a period.

6. The method of claim 1, wherein the second information comprises context information of the UE, wherein the context information comprises data rate, sensor-level information, or communication access information.

7. The method of claim 1, wherein the first influencer application operates on the UE or a server communicatively connected with the UE.

8. The method of claim 1, further comprising detecting, based on a criteria, one or more actions of the first influencer application that has an effect on the influenced application.

9. An apparatus comprising:
a processor; and
memory coupled with the processor, the memory comprising executable instructions stored thereon that when executed by the processor cause the processor to effectuate operations comprising:
receiving a message from an influenced application, the message indicating the influenced application may be affected by an activity of one or more influencer applications that serves a user equipment (UE);
wherein the message comprises first information, the first information comprising a description of the influenced application, a description of the one or more influencer applications, an expected action to be taken by a coordinator service, or an allowed action to be taken by the coordinator service;
identifying a first influencer application of the one or more influencer applications;
receiving second information associated with the first influencer application; and
based on the second information, determining actions to be taken by the coordinator service.

10. The apparatus of claim 9, further comprising maintaining an influence record of the influenced application, wherein the influence record comprises an operation of the first influencer application and an action to be taken by the coordinator service.

11. The apparatus of claim 9, wherein the description of the influenced application comprises a schedule of an application client (AC) associated with the influenced application or callback address of the influenced AC.

12. The apparatus of claim 9, wherein the description of the one or more influencer applications comprises a first identifier of the first influencer application when a threshold has been met that indicates influencing of an influenced application or a second identifier for indicating an influencer application server associated with the one or more influencer applications.

13. The apparatus of claim 9, wherein the second information comprises application characteristics of the first influencer application, wherein the characteristics of the first influencer application comprises expected traffic over a period.

14. The apparatus of claim 9, wherein the second information comprises context information of the UE, wherein the context information comprises data rate, sensor-level information, or communication access information.

15. The apparatus of claim 9, wherein the first influencer application operates on the UE or a server communicatively connected with the UE.

16. The apparatus of claim 9, further comprising detecting, based on a criteria, one or more actions of the first influencer application that has an effect on the influenced application.

17. A computer readable storage medium storing computer executable instructions that when executed by a computing device cause the computing device to effectuate operations comprising:
receiving a message from an influenced application, the message indicating the influenced application may be affected by an activity of one or more influencer applications that serves a user equipment (UE);
wherein the message comprises first information, the first information comprising a description of the influenced application, a description of the one or more influencer applications, an expected action to be taken by a coordinator service, or an allowed action to be taken by the coordinator service;
identifying a first influencer application of the one or more influencer applications;
receiving second information associated with the first influencer application; and
based on the second information, determining actions to be taken by the coordinator service.

18. The computer readable storage medium of claim 17, further comprising maintaining an influence record of the influenced application, wherein the influence record comprises an operation of the first influencer application and an action to be taken by the coordinator service.

19. The computer readable storage medium of claim 17, wherein the description of the influenced application comprises a schedule of an application client (AC) associated with the influenced application or callback address of the influenced AC.

20. The computer readable storage medium of claim 17, wherein the description of the one or more influencer applications comprises a first identifier of the first influencer application when a threshold has been met that indicates influencing of an influenced application or a second identifier for indicating an influencer application server associated with the one or more influencer applications.
